(19) United States
(12) Patent Application Publication
(10) Pub. No.: US 2005/0208423 A1
(43) Pub. Date: Sep. 22, 2005

(54) Lithographic printing plate precursor

(75) Inventors: Tomoyoshi Mitsumoto, Haibara-gun (JP); Norio Aoshima, Haibara-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/082,028

(22) Filed: Mar. 17, 2005

(30) Foreign Application Priority Data
Mar. 19, 2004 (JP) P.2004-079960
Mar. 19, 2004 (JP) P.2004-080587
Apr. 19, 2004 (JP) P.2004-122854

(51) Int. Cl. G03C 1/492

(52) U.S. Cl. 430/270.1; 101/457

(57) ABSTRACT

A lithographic printing plate precursor comprising a support and an image-recording layer that contains (A) a radical polymerization initiator, (B) a polymerizable compound and (C) a lipophilic binder polymer substantially not containing an acid group and is capable of being removed with either or both of printing ink and dampening water, wherein the polymerizable compound has at least one structure selected from (1) an ethylene oxide chain, (2) an alcoholic hydroxy group and (3) an isocyanuric acid structure in the molecule thereof.

### FIELD OF THE INVENTION

The present invention relates to a lithographic printing plate precursor capable of conducting printing without undergoing a development processing step, and a lithographic printing method using the same.

### BACKGROUND OF THE INVENTION

In general, a lithographic printing plate has a surface composed of an oleophilic image area and a hydrophilic non-image area. Lithographic printing is a printing method comprising supplying alternately dampening water and oily ink on the surface of lithographic printing plate, making the hydrophilic non-image area a dampening water-receptive area (ink unreceptive area) and depositing the oily ink only to the oleophilic image area by utilizing the nature of the dampening water and oily ink to repel with each other, and then transferring the ink to a printing material, for example, paper.

In order to produce the lithographic printing plate, a lithographic printing plate precursor (PS plate) comprising a hydrophilic support having provided thereon an oleophilic photosensitive resin layer (image-recording layer) has heretofore been broadly used. Ordinarily, a lithographic printing plate is obtained by conducting plate making by a method of exposing the lithographic printing plate precursor through an original, for example, a lith film, and then treating the exposed lithographic printing plate precursor to remove the image-recording layer in the undesirable non-image area by dissolving with a developer, for example, an aqueous alkaline solution or an organic solvent thereby revealing the hydrophilic surface of support to form the non-image area while leaving the image-recording layer in the image area.

The step of removing the image-recording layer in the undesirable non-image area by dissolving, for example, with a developer is required in the hitherto known plate-making process of lithographic printing plate precursor. However, it is one of the subjects to save or simplify such an additional wet treatment described above. Particularly, since disposal of liquid wastes discharged accompanying the wet treatment has become a great concern throughout the field of industry in view of the consideration for global environment in recent years, the demand for the solution of the above-described subject has been increased more and more.

As one of simple plate-making methods in response to the above-described requirement, it has been proposed a method referred to as on-machine development wherein a lithographic printing plate precursor having an image-recording layer capable of being removed in conventional printing process is used and after exposure, the undesirable area of the image-recording layer is removed on a printing machine to prepare a lithographic printing plate.

Specific methods of the on-machine development include, for example, a method of using a lithographic printing plate precursor having an image-recording layer that can be dissolved or dispersed in dampening water, an ink solvent or an emulsion of dampening water and ink, a method of physically removing an image-recording layer by contact with rollers or a blanket of a printing machine, and a method of lowering cohesion of the image-recording layer or adhesion between an image-recording layer and a support upon impregnation of dampening water, ink solvent or the like and then physically removing the image-recording layer by contact with rollers or a blanket of a printing machine.

In the invention, unless otherwise indicated particularly, the term “development processing step” means a method and a step of using an apparatus (ordinarily, an automatic developing machine) other than a printing machine and removing the undesired area of the image-recording layer in the lithographic printing plate precursor upon contact with liquid (ordinarily, an alkaline developer) thereby revealing a hydrophilic surface of the support. The term “on-machine development” means a method and a step of removing the undesirable area of the image-recording layer in the lithographic printing plate precursor upon contact with liquid (ordinarily, printing ink and/or dampening water) by using a printing machine thereby revealing a hydrophilic surface of the support.

On the other hand, digitalized technique of electronically processing, accumulating and outputting image information has been popularized in recent years, and various new image outputting systems responding to the digitalized technique have been put into practical use. Correspondingly, attention has been drawn to a computer-to-plate technique of carrying digitalized image information on highly converging radiation, for example, laser light and conducting scanning exposure of a lithographic printing plate precursor with the light thereby directly preparing a lithographic printing plate without using a lith film. Thus, it is one of important technical subjects to obtain a lithographic printing plate precursor adaptable to the technique described above,

As described above, simplification, introduction of dry process and saving of treatment for print-making operation have been demanded strongly more and more than ever before both in view of the consideration on the global environment and the adaptation to digitalization.

In response to such demands, for example, a lithographic printing plate precursor having provided on a hydrophilic support, an image-forming layer in which hydrophobic thermoplastic polymer particles are dispersed in a hydrophilic binder is described in Patent Document 1. It is described in Patent Document 1 that the lithographic printing plate precursor can be exposed to an infrared laser to agglomerate the hydrophobic thermoplastic polymer particles by heat thereby forming an image, and mounted on a cylinder of a printing machine to carry out on-machine development by supplying dampening water and/or ink.

However, it has been found that while the method of forming image by the agglomeration of fine particles only upon thermal fusion shows good on-machine development property, the strength of image is weak and printing durability is insufficient.

Therefore, it has been proposed to improve the printing durability by utilizing a polymerization reaction. For instance, a lithographic printing plate precursor having provided on a hydrophilic support, an image-recording layer (heat-sensitive layer) including microcapsules containing a polymerizable compound encapsulated therein is described in Patent Document 2. Further, a lithographic printing plate precursor having provided on a support, an image-recording layer (photosensitive layer) containing an infrared absorbing agent, a radical polymerization initiator and a polymerizable compound is described in Patent Document 3.

Moreover, it is described in Patent Document 4 that a lithographic printing plate precursor having good on-machine development property, preventing form printing stain and exhibiting high printing durability is provided by incorporating a compound having an ethylene oxide chain into an image-forming layer containing a hydrophobic precursor, a hydrophilic resin and a light to heat converting agent.
Patent Document 1: Japanese Patent No. 2938397
Patent Document 2: JP-A 2001-277740 (the term “JP-A” as used herein means an “unexamined published Japanese patent application”)
Patent Document 3: JP-A 2002-287334
Patent Document 4: JP-A 2002-365789

However, the above-described techniques are still insufficient in view of the compatibility between the on-machine development property and other characteristics, particularly, reproducibility of fine lines, printing durability, preservation stability or prevention of adhesion of component removed by development to a water-supplying roller.

### SUMMARY OF INVENTION

Therefore, an object of the invention is to resolve these problems and specifically, to provide a lithographic printing plate precursor of on-machine development type that has good on-machine development property and good reproducibility of fine lines, printing durability, preservation stability and prevention of adhesion of component removed by development to a water-supplying roller, as well as a lithographic printing method using the same.

As a result of intensive investigations, the present inventor has found that the above-described objects can be achieved by using a polymerizable compound having a specific structure and a binder polymer substantially not containing an acid group in combination, to complete the invention.

Specifically, the invention includes the following items.
1. A lithographic printing plate precursor comprising a support and an image-recording layer that contains (A) a radical polymerization initiator, (B) a polymerizable compound and (C) a lipophilic binder polymer substantially not containing an acid group and is capable of being removed with either or both of printing ink and dampening water, wherein the polymerizable compound has at least one structure selected from (1) an ethylene oxide chain, (2) an alcoholic hydroxy group and (3) an isocyanuric acid structure in the molecule thereof.
2. The lithographic printing plate precursor as described in item 1 above, wherein the image-recording layer farther contains (D) a light to heat converting agent.
3. The lithographic printing plate precursor as described in item 1 or 2 above, wherein the support has an undercoat layer containing a compound having a crosslinking group.
4. The lithographic printing plate precursor as described in item 3 above, wherein the compound further has an adsorbing group.
5. The lithographic printing plate precursor as described in any one of items 1 to 4 above wherein the image-recording layer further contains (E) a microcapsule.
6. The lithographic printing plate precursor as described in any one of items 1 to 5 above, which further comprises a protective layer provided on the image-recording layer.
7. The lithographic printing plate precursor as described in 6 above, wherein the protective layer has a thickness of from 0.1 to 5 μm.
8. A lithographic printing method, which comprises; mounting the lithographic printing plate precursor as described in any one of items 1 to 7 above on a printing machine and then imagewise exposing the lithographic printing plate precursor by a laser; or imagewise exposing the lithographic printing plate precursor as described in any one of items 1 to 7 above by a laser and then mounting the exposed lithographic printing plate precursor to a printing machine; and subsequently supplying printing ink and dampening water to the exposed lithographic printing plate precursor, thereby removing an unexposed area of the image-recording layer to conduct printing.

### DETAILED DESCRIPTION OF THE INVENTION

According to the invention, a lithographic printing plate precursor of on-machine development type that is capable of printing without undergoing the development processing step after exposure and has good on-machine development property and good reproducibility of fine lines, printing durability, preservation stability and prevention of adhesion of component removed by development to a water-supplying roller, and as well as a lithographic printing method using the same can be provided.

[Image-Recording Layer]

The image-recording layer according to the invention contains (A) a radical polymerization initiator, (B) a polymerizable compound (hereinafter also referred to as a “polymerizable compound having the specific structure”) having at least one structure selected from (1) an ethylene oxide chain, (2) an alcoholic hydroxy group and (3) an isocyanuric acid structure in the molecule thereof, and (C) a lipophilic binder polymer substantially not containing an acid group, and is capable of being removed with either or both of printing ink and dampening water.

The constituting components of the image-recording layer will be described in more detail below.

<Polymerizable Compound Having the Specific Structure>

(1) Polymerizable Compound Having an Ethylene Oxide Chain

The radical polymerizable compound (hereinafter also referred to as an “EO chain-containing polymerizable compound”) having an ethylene oxide chain (EO chain) in the molecule thereof is an addition-polymerizable compound having at least one ethylenically unsaturated double bond and an EO chain. The compound preferably contains two or more ethylenically unsaturated double bonds.

The EO chain-containing polymerizable compound according to the invention is especially effective for resolving the problem of preservation stability in that although a lithographic printing plate precursor of on-machine development type is capable of conducting on-machine development just after the production, in the case of preservation thereof for a long period of time, it cannot be carried out the on-machine development due to increase in adherence between the support and the image-recording layer.

Although the mechanism of making the improvement in the preservation stability is not clear in detail, it is believed that the introduction of ethylene oxide chain having an appropriate hydrophilicity into the molecule enhances water permeability to improve the developing property, and since an interaction between the ethylene oxide chain and a support is extremely weak in comparison with other hydrophilic polar groups, variation in the adherence during the preservation is small despite of the high developing property thereby obtaining the effect of improving the preservation stability. Further, unlike with only the addition of a compound having the ethylene oxide chain, by introducing the ethylene oxide chain into a polymerizable compound, it is incorporated into the polymerization reaction to cure the layer. As a result, an amount of the unreacted compound in the cured layer decreases and the image strength at the time of printing increases, resulting in improvements in the sensitivity and printing durability. Thus, compatibility between the on-machine development property and the image-forming property can be achieved.

Examples of the ethylenically unsaturated double bond contained in the EO chain-containing polymerizable compound according to the invention include a vinyl group, a 1-propenyl group, an isopropenyl group, an ally group, a 2-butenyl group, a 1,3-butadienyl group, an acryloyl group, a methacryloyl group, a crotonoyl group, a methylenesuccinyl group and a dialkylmaleimido group. Among these, a vinyl group, an acryloyl group and a mnethacryloyl group are preferred, and an acryloyl group and a methacryloyl group are more preferred.

The EO chain according to the invention has a structure where ethylene oxide groups are repeatedly connected and is represented by a formula of (—CH₂—CH₂—O—)ₙ. In the formula, n preferably represents an integer of from 2 to 15, more preferably an integer of from 2 to 9.

A content of the ethylene oxide group per mole of the EO chain-containing polymerizable compound is preferably from 1 to 20 meq./g, particularly preferably from 2 to 13 meq./g. In the range, good preservation stability can be obtained even the storage at high temperature without accompanying with degradation of the images forming property (degradation of the sensitivity and printing durability) due to deterioration of the water resistance.

Examples of the radical polymerizable compound having the ethylene oxide chain in the molecule according to the invention include (1) a compound obtained by reacting an alcohol having an ethylene oxide (EO) group with a carboxylic acid having an unsaturated double bond, and (2) a compound obtained by reacting an alcohol having an ethylene oxide group with a polyfunctional isocyanate and then adding to the resulting compound a monomer having a hydroxy group as described in JP-B-48-41708 (the term “JP-B” as used herein means an “examined Japanese patent publication”),

The radical polymerizable compound having the ethylenically unsaturated double bond and the EO chain is not particularly restricted. Specific examples thereof include a compound having a structure represented by formula (i) shown below and a compound represented by formula (ii) shown below.
CH₂═C(R¹)—COO—(C₂H₄O)ₙ—X— (i)
CH₂═C(R¹)—COO—(C₂H₄)ₙ—Y (ii)

In formula (i), R¹ represents a hydrogen atom or a methyl group, n represents an integer of from 2 to 15, and X represents a connecting group, for example, an alkylene group, an arylene group, alkyleneoxy group or an aryleneoxy group, or a single bond. In formula (ii), R¹ and n have the same meanings as defined in formula (i) respectively, and Y represents an alkyl group, an aryl group or an acyl group.

Specific examples of the compound include the compounds set forth below, but the invention should not be construed as being limited thereto.

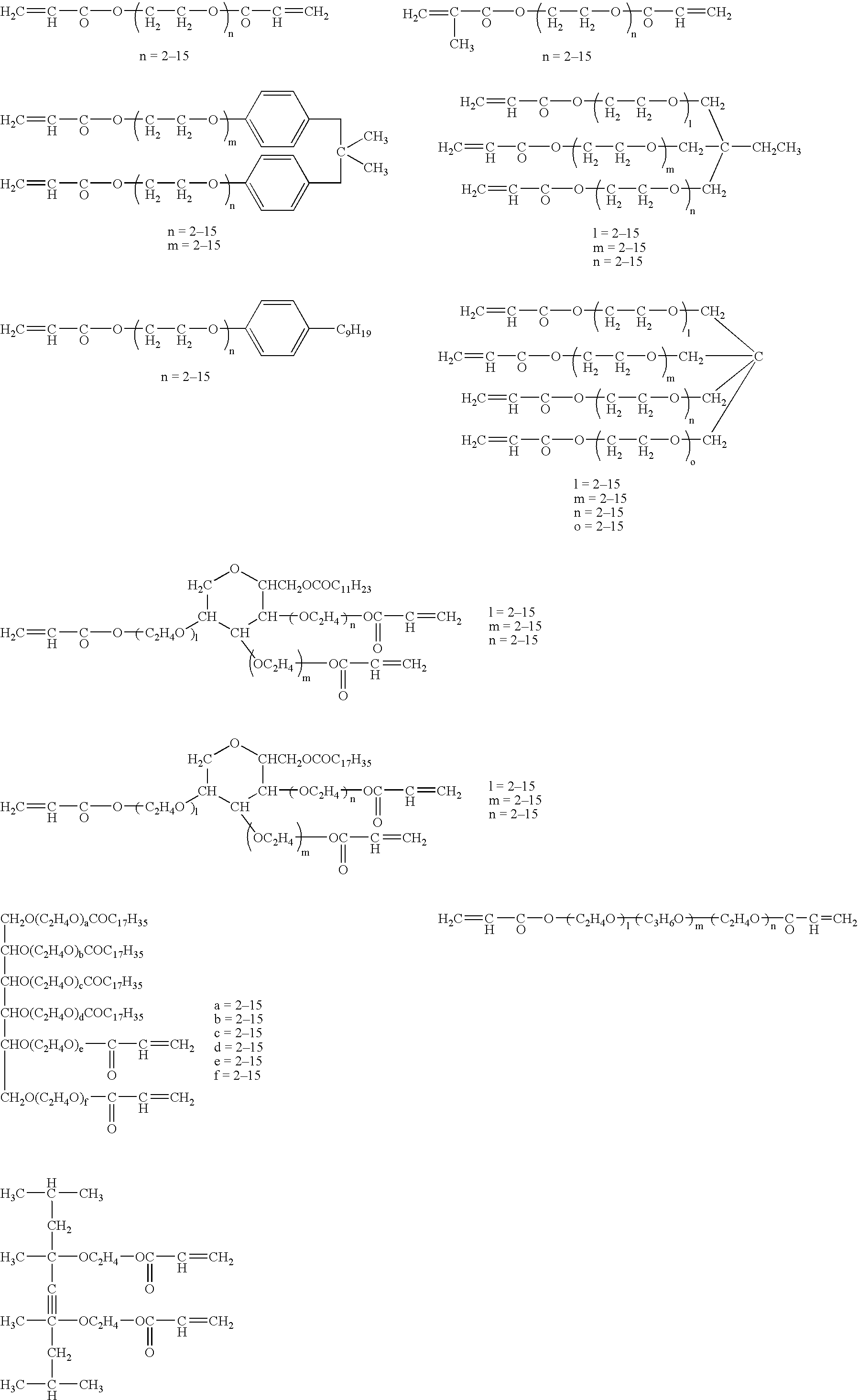

Other examples of the EO chain-containing polymerizable compound include a vinyl urethane compound containing two or more polymerizable vinyl groups in the molecule obtained by adding 2-hydroxyethyl methacrylate to a polyisocyanate compound having two or more isocyanate groups in the molecule.

(2) Polymerizable Compound Having an Alcoholic Hydroxy Group

In the radical polymerizable compound having an alcoholic hydroxy group in the molecule (hereinafter also referred to as a “hydroxy group-containing monomer”), which is one of the polymerizable compounds having the specific structure according to the invention, a content of the alcoholic hydroxy group in the molecule is preferably from 1.9 to 20 meq./g, more preferably from 3 to 11 meq./g.

The hydroxy group-containing monomer is effective particularly for improvements in the on-machine development property, inking property and printing durability. Although the compound having an alcoholic hydroxy group is hydrophilic and ordinarily considered to be disadvantageous in the inking property and printing durability, it exhibits an unexpected effect of improvements in the inking property and printing durability. The mechanism of exerting the effect is not quite clear, but it is believed that the alcoholic hydroxy group in the polymerizable compound undergoes interaction with the component of the image-recording layer through a hydrogen bond to the enhance cohesive energy density in the exposed and polymerized area of the image-recording layer, thereby increasing the image strength.

The hydroxy group-containing monomer according to the invention contains as the radical polymerizable group, an ethylenically unsaturated double bond. Examples of the ethylenically unsaturated double bond include a vinyl group, a 1-propenyl group, an isopropenyl group, an ally group, a 2-butenyl group, a 1,3-butadienyl group, an acryloyl group, a methacryloyl group, a crotonoyl group, a methylenesuccinyl group and a dialkylmaleimido group. Among these, a vinyl group, an acryloyl group and a methacryloyl group are preferred, and an acryloyl group and a methacryloyl group are more preferred.

The hydroxy group-containing monomer is well known in the field of art, and that adopting to the above-described content of hydroxy group can be selected from known compounds without particular limitation. Among them, for example, an ester of an aliphatic polyhydric alcohol compound with an unsaturated carboxylic acid and an adduct of a compound having a plurality of epoxy groups and an unsaturated carboxylic acid are preferably exemplified.

Specific examples of the hydroxy group-containing monomer are set forth below, but the invention should not be construed as being limited thereto.

Examples of the ester of an aliphatic polyhydric alcohol compound with an unsaturated carboxylic acid include pentaerythritol triacrylate, trimethylolpropane diacrylate, dipentaerythritol tetraacrylate, glycerin monoacrylate, glycerin diacrylate, sorbitol triacrylate, sorbitol tetraacrylate, pentaerythritol trimethacrylate, trimethylolpropane dimethacrylate, dipentaerythritol tetramethacrylate, glycerin monomethaclylate, glycerin dimethacrylate, sorbitol trimethacrylate and sorbitol tetramethacrylate.

Examples of the adduct of a compound having a plurality of epoxy groups and an unsaturated carboxylic acid include the compounds set forth below. 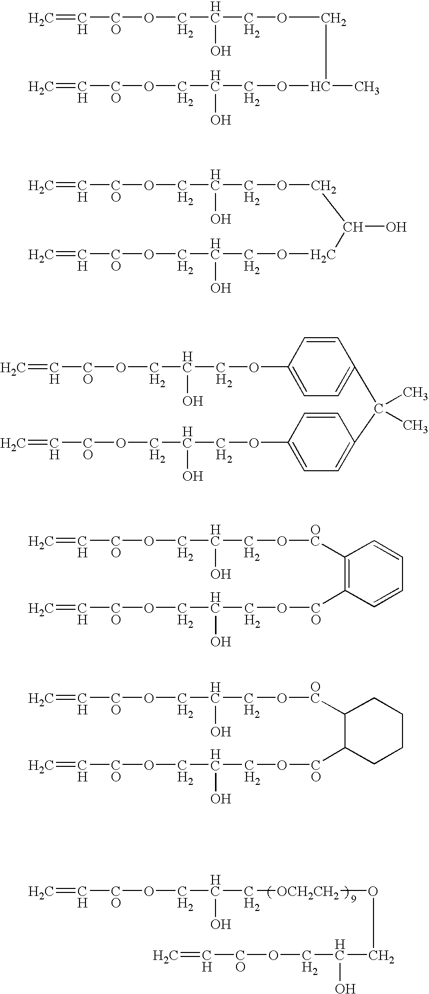
(3) Polymerizable Compound Having an Isocyanuric Acid Structure

The polymerizable compound having an isocyanuric acid structure in the molecule, which is other example of the polymerizable compounds having the specific structure according to the invention, includes a compound represented by the following formula: 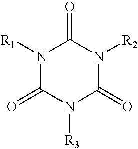
wherein R¹ to R₃ each independently represents a hydrogen atom, a polymerizable group or —R₄—OH, provided that at last one of R₁ to R₃ is a polymerizable group, and R₄ represents an alkylene group.

The polymerizable group includes a (meth)acryloyl group, a (meth)acryloyloxyalkyl group and an allyl group. The alkyl group in the (meth)acryloyloxyalkyl group is preferably an alkyl group having from 1 to 5 carbon atoms. The alkylene group represented by R₄ is preferably an alkylene group having from 1 to 6 carbon atoms.

In the present specification, “acryloyl” and “methacryloyl” are collectively referred to as “(meth)acryloyl”.

Of the polymerizable compounds having an isocyanuric acid structure, those having two or more (meth)acryloyl groups are preferred from the standpoint of polymerization efficiency.

Further, the compound having a hydroxy group is preferred since it exerts high printing durability in the case of using it in combination with the image-recording layer containing microcapsules. This is believed that the hydroxy group interacts with a microcapsule wall or a dispersing agent to increase strength of the image area.

Specific examples of the polymerizable compounds having an isocyanuric acid structure according to the invention include tris[(meth)acryloyloxymethyl]isocyanurate, tris[(meth)acryloyloxyethyl]isocyanurate, tris[(meth)acryloyloxypropyl]isocyanurate, triallylisocyanurate, bis[(meth)acryloyloxyethyl]hydroxyethyl isocyanurate, bis[(meth)acryloyloxymethyl]isocyanurate, allyl hydroxyethyl ethyl isocyanurate and (meth)acryloyloxyethyl isocyanuraye.

The polymerizable compounds having an isocyanuric acid structure is especially effective for resolving the problem in that the substance removed by on-machine development deposits as a scum on the water-supplying roller to disturb the supply of dampening water.

The on-machine development is carried out to remove the unexposed area of the image-recording layer by power of dampening water and ink dissolving the image-recording layer and physical power of a water-supplying roller and an inking roller supplying dampening water and ink respectively. The polymerizable compounds having an isocyanuric acid structure has an unusually high effect of decreasing the on-machine development property of the image-recording layer due to the dampening water and water-supplying roller and increasing the on-machine development property due to the ink and inking roller in comparison with other organic solvent-soluble polymerizable compounds. Thus, it is believed that the substance removed by on-machine development hardly deposits as a scum on the water-supplying roller.

A content of the polymerizable compound having the specific structure according to the invention in the image-recording layer is preferably from 5 to 80% by weight, more preferably from 25 to 75% by weight, based on the slid content of the image-recording layer.

In the invention, two or more of the polymerizable compounds having the specific structure can be used. Further, a polymerizable compound other than the polymerizable compound having the specific structure may be used together. Examples of the polymerizable compound other than the polymerizable compound having the specific structure include polymerizable compounds having at least one ethylenically unsaturated bond, preferably two or more ethylenically unsaturated bonds known in the field of art.

In the case of using the polymerizable compound other than the polymerizable compound having the specific structure, a ratio of the polymerizable compound having the specific structure is preferably 30% by weight or more, more preferably 50% by weight or more, based on the whole polymerizable compound. In the above-described range, the effects of the polymerizable compound having the specific structure are sufficiently exerted.

<(A) Radical Polymerization Initiator>

The radical polymerization initiator (hereinafter, also referred to as “radical generator” or simply “polymerization initiator”) for use in the invention is a compound that generates a radical upon light or heat energy to initiate or accelerate polymerization of the compound having a polymerizable unsaturated group. The radical generator used is appropriately selected from known polymerization initiators and compounds containing a bond having a small bond dissociation energy.

The radical-generating compounds include, for example, organic halogen compounds, carbonyl compounds, organic peroxides, azo compounds, azido compounds, metallocene compounds, hexaarylbiimidazole compounds, organic boron compounds, disulfone compounds, oximester compounds and onium salt compounds.

The organic halogen compounds specifically include, for example, compounds described in Wakabayashi et al., Bull. Chem. Soc. Japan, 42, 2924 (1969), U.S. Pat. No. 3,905,815, JP-B-46-4605, JP-A-48-36281, JP-A-53-133428, JP-A-55-32070, JP-A-60-239736, JP-A-61-169835, JP-A-61-169837, JP-A-62-58241, JP-A-62-212401, JP-A-63-70243, JP-A-63-298339 and M. P. Hutt, Journal of Heterocyclic Chemistry, 1, No. 3 (1970). Among them, oxazole compounds and s-triazine compounds each substituted with a trihalomethyl group are preferable,

More preferably, s-triazine derivatives in which at least one of mono-, di- or tri-halogen substituted methyl group is connected to the s-triazine ring and oxadiazole derivative in which at least one of mono-, di- or tri-halogen substituted methyl group is connected to the oxadiazole ring are exemplified. Specific examples thereof include 2,4,6-tris(monochloromethyl)-s-triazine, 2,4,6-tris(dichloromethyl)-s-triazine, 2,4,6-tris(trichloromethyl)-s-triazine, 2-methyl4,6-bis(trichloromethyl)-s-triazine, 2-n-propyl-4,6-bis(trichloromethyl)-s-triazine, 2-(α,α,β-trichloroethyl)-4,6-bis(trichloromethyl)-s-triazine, 2-(3,4-epoxyphenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl-4,6-bis(trichloromethyl)-s-triazine, 2-(p-isopropyloxystyryl-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, 2-methoxy-4,6-bis(tribromomethyl)-s-triazine and the compounds set forth below.

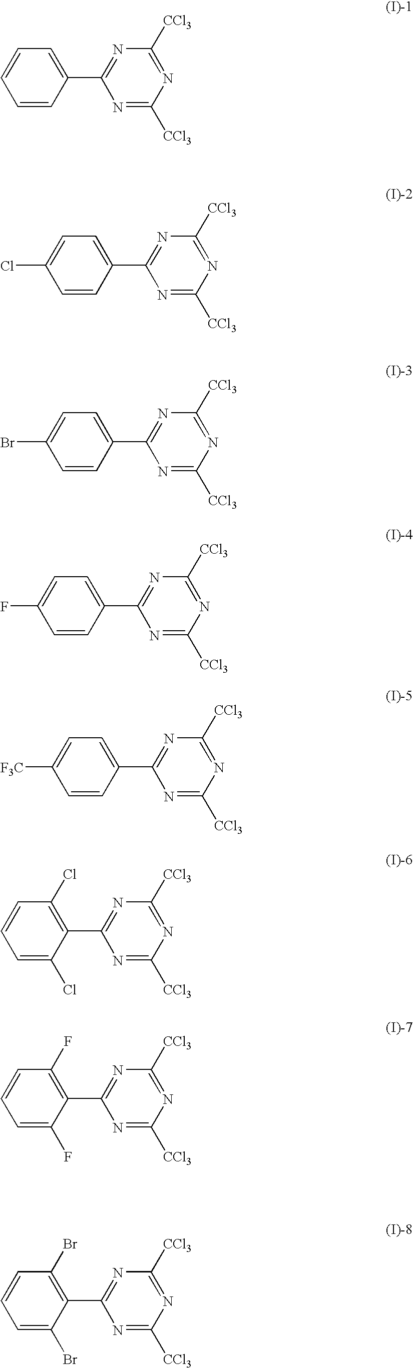

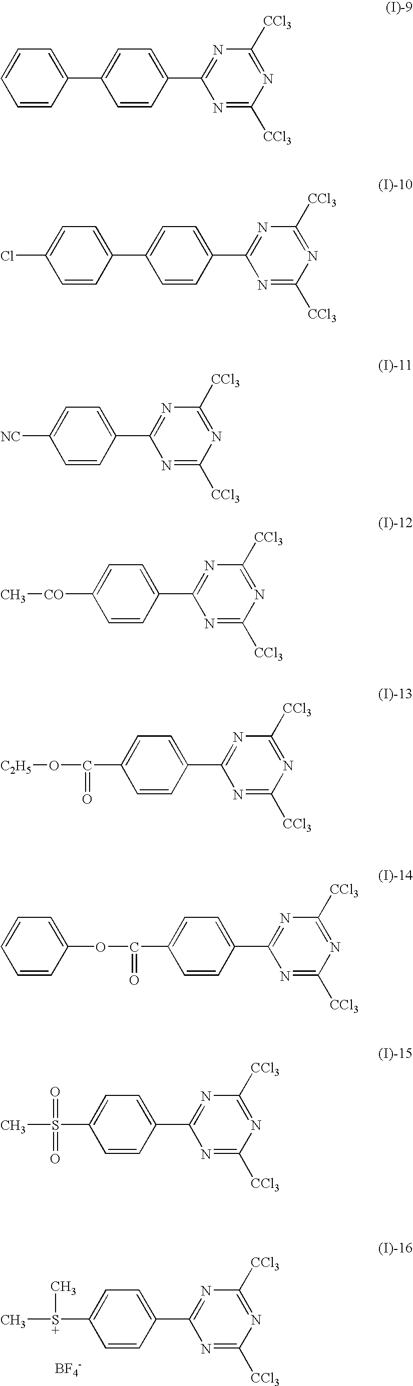

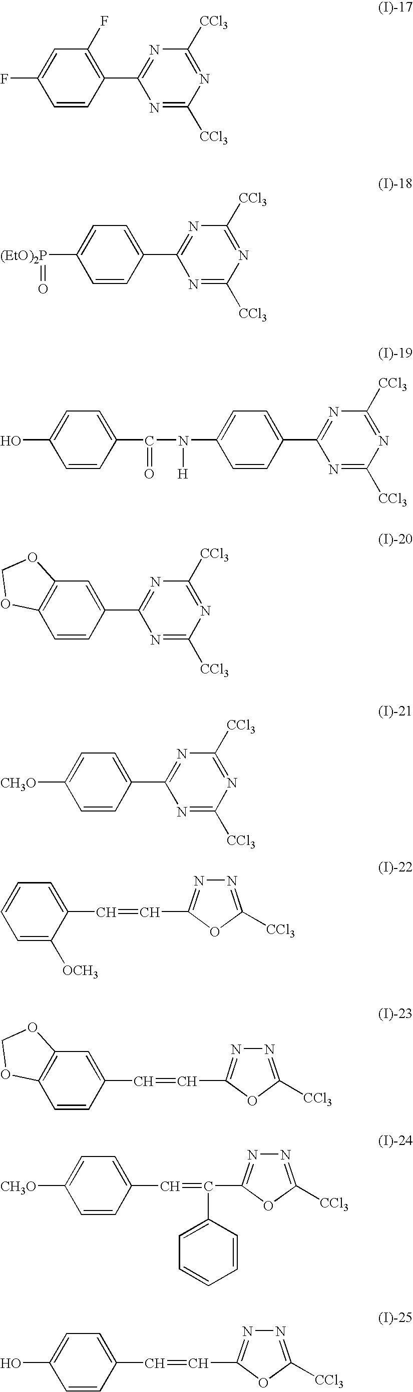

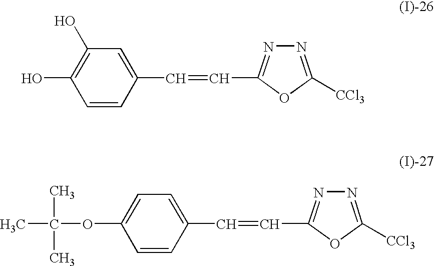

The carbonyl compounds described above include, for example, benzophenone derivatives, e.g., benzophenone, Michler's ketone, 2-methylbenzophenone, 3-methylbenzophenone, 4-methylbenzophenone, 2-chlorobenzophenone, 4-bromobenzophenone or 2-carboxybenzophenone, acetophenone derivatives, e.g., 2,2-dimethoxy-2-phenylacetophenone, 2,2-diethoxyacetophenone, 1-hydroxycyclohexylphenylketone, α-hydroxy-2-methylphenylpropane, 1-hydroxy-1-methylethyl-(p-isopropylphenyl)ketone, 1-hydroxy-1-(p-dodecylphenyl)ketone, 2-methyl-(4′-(methylthio)phenyl)-2-morpholino-1-propane or 1,1,1-trichloromethyl(p-butylphenyl)ketone, thioxantone derivatives, e.g., thioxantone, 2-ethylthioxantone, 2-isopropylthioxantone, 2-chlorothioxantone, 2,4-dimetylthioxantone, 2,4-dietylthioxantone or 2,4-diisopropylthioxantone, and benzoic acid ester derivatives, e.g., ethyl p-dimethylaminobenzoate or ethyl p-diethylaminobenzoate.

The azo compounds described above include, for example, azo compounds described in JP-A-8-108621.

The organic peroxides described above include, for example, trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butylhydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-xanoyl peroxide, succinic peroxide, benzoyl peroxide, 2,4-dichlorobenzoyl peroxide, diisopropylperoxy dicarbonate, di-2-ethylhexylperoxy dicarbonate, di-2-ethoxyethylperoxy dicarbonate, dimethoxyisopropylperoxy dicarbonate, di(3-methyl-3-methoxybutyl)peroxy dicarbonate, tert-butylperoxy acetate, tert-butylperoxy pivalate, tert-butylperoxy neodecanoate, tert-butylperoxy octanoate, tert-butylperoxy laurate, tertiary carbonate, 3,3′,4,4′-tetra(tert-butylperoxycarbonyl)benzophenone, 3,3′,4,4′-tetra(tert-hexylperoxycarbonyl)benzophenone, 3,3′,4,4′-tetra(p-isopropylcumylperoxycarbonyl)benzophenone, carbonyl di(tert-butylperoxydihydrogen diphthalate) and carbonyl di(tert-hexylperoxydihydrogen diphthalate).

The metallocene compounds described above include, for example, various titanocene compounds described in JP-A-59-152396, JP-A-61-151197, JP-A-63-41484, JP-A-2-249, JP-A-2-4705 and JP-A-5-83588, for example, dicyclopentadienyl-Ti-bisphenyl, dicyclopentadienyl-Ti-bis-2,6-difluorophen-1-yl, dicyclopentadienyl-Ti-bis-2,4-difluorophen-1-yl, dicyclopentadienyl-Ti-bis-2,4,6-trifluorophen-1-yl, dicyclopentadienyl-Ti-bis-2,3,5,6-tetrafluorophen-1-yl, dicyclopentadienyl-Ti-bis-2,3,4,5,6-pentafluorophen-1-yl, dimethylcyclopentadienyl-Ti-bis-2,6-difluorophen-1-yl, dimethylcyclopentadienyl-Ti-bis-2,4,6-trifluorophen-1-yl, dimethylcyclopentadienyl-Ti-bis-2,3,5,6-tetrafluorophen-1-yl or dimethylcyclopentadienyl-Ti-bis-2,3,4,5,6-pentafluorophen-1-yl, and iron-arene complexes described in JP-A-1-304453 and JP-A-1-152109.

The hexaarylbiimidazole compounds described above include, for example, various compounds described in JP-B-6-29285 and U.S. Pat. Nos. 3,479,185, 4,311,783 and 4,622,286, specifically, for example, 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole and 2,2′-bis(o-trifluoromethylphenyl)-4,4′,5,5′-tetraphenylbiimidazole.

The organic boron compounds described above include, for example, organic boric acid salts described in JP-A-62-143044, JP-A-62-150242, JP-A-9-188685, JP-A-9-188686, JP-A-9-188710, JP-A-2000-131837, JP-A-2002-107916, Japanese Patent 2764769, JP-A-2002-116539 and Martin Kunz, Rad Tech '98, Proceeding, Apr. 19-22, 1998, Chicago, organic boron sulfonium complexes or organic boron oxosulfonium complexes described in JP-A-6-157623, JP-A-6-175564 and JP-A-6-175561, organic boron iodonium complexes described in JP-A-6-175554 and JP-A-6-175553, organic boron phosphonium complexes described in JP-A-9-188710, and organic boron transition metal coordination complexes described in JP-A-6-348011, JP-A-7-128785, JP-A-7-140589, JP-A-7-306527 and JP-A-7-292014.

The disulfone compounds described above include, for example, compounds described in JP-A-61-166544 and JP-A-2003-328465.

The oximester compounds described above include, for example, compounds described in J. C. S. Perkin II, 1653-1660 (1979), J. C. S. Perkin II, 156-162 (1979), Journal of Photopolymer Science and Technology, 202-232 (1995), IP-A-2000-66385 and JP-A-2000-80068, and specifically, compounds represented by the following formulae:

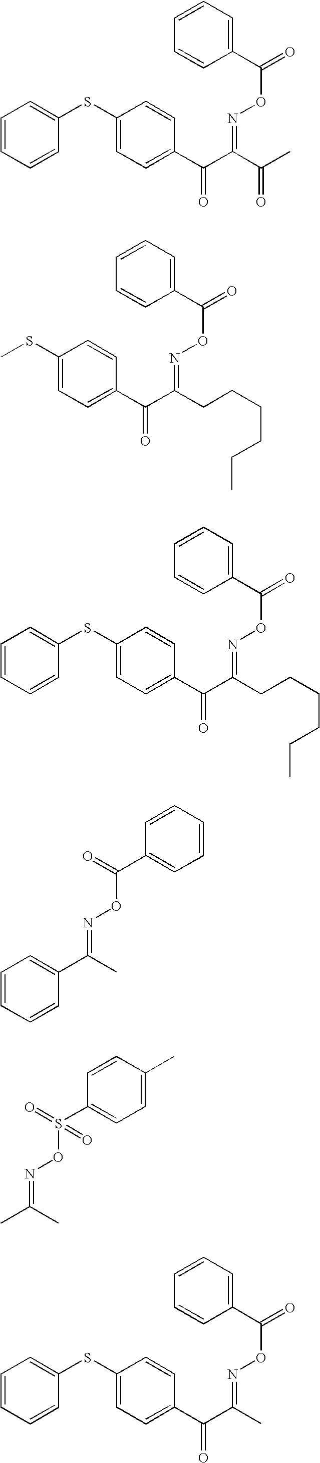

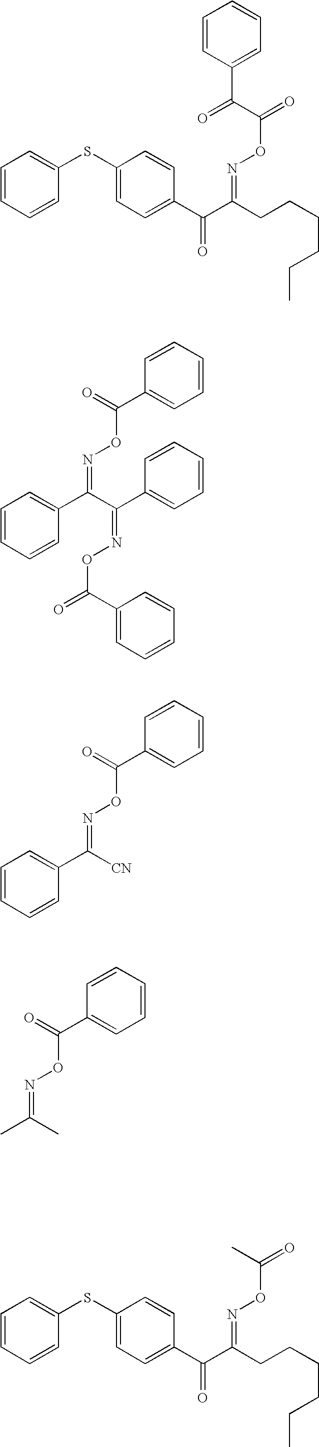

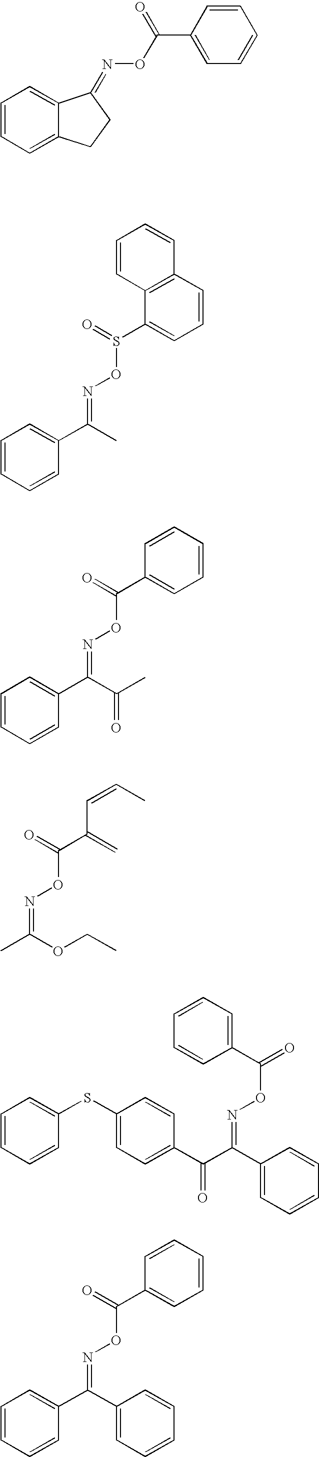

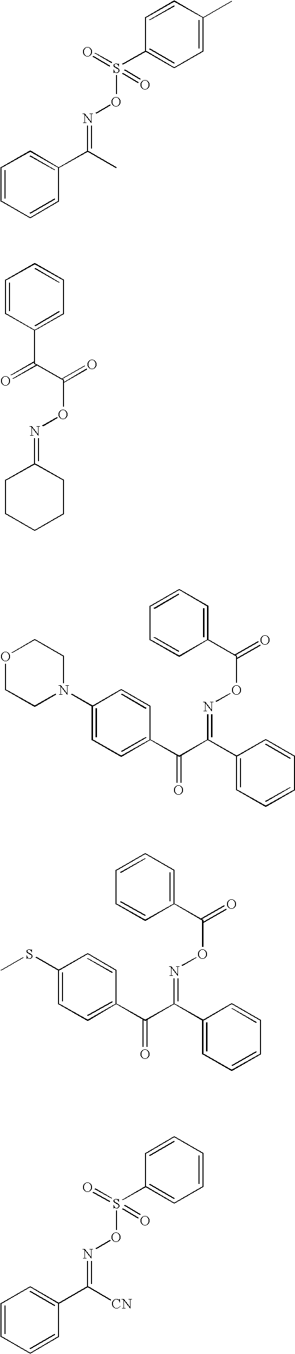

The onium salt compounds described above include, for example, diazonium salts described in S. I. Schlesinger, Photogr. Sci. Eng. 18, 387 (1974) and T. S. Bal et al., Polymer, 21, 423 (1980), ammoniumn salts described in U.S. Pat. No. 4,069,055 and JP-A-4-365049, phosphonium salts described in U.S. Pat. Nos. 4,069,055 and 4,069,056, iodonium salts described in European Patent 104,143, U.S. Pat. Nos. 339,049 and 410,201, JP-A-2-150848 and JP-A-2-296514, sulfonium salts described in European Patents 370,693, 390,214, 233,567, 297,443 and 297,442, U.S. Pat. Nos. 4,933,377, 161,811, 410,201, 339,049, 4,760,013, 4,734,444 and 2,833,827 and German Patents 2,904,626, 3,604,580 and 3,604,581, selenonium salts described in J. V. Crivello et al., Macromolecules, 10 (6), 1307 (1977) and J. V. Crivello et al., J. Polymer Sci. Polymer Chem. Ed., 17, 1047 (1979), and arsonium salts described in C. S. Wen et al., Teh. Proc. Conf. Rad. Curing ASIA, p. 478, Tokyo, October (1988).

In the invention, the onium salt functions not as an acid generator, but as an ionic radical polymerization initiator.

The onium salts preferably used in the invention include onium salts represented by the following formulae (RI-I) to (RI-RIII):

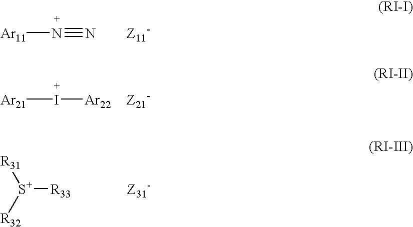

In formula (RI-I), Ar₁₁ represents an aryl group having 20 or less carbon atoms, which may have 1 to 6 substituents. Preferred example of the substituent includes an alkyl group having from 1 to 12 carbon atoms, an alkenyl group having from 2 to 12 carbon atoms, an alkynyl group having from 2 to 12 carbon atoms, an aryl group having from 6 to 12 carbon atoms, an alkoxy group having from 1 to 12 carbon atoms, an aryloxy group having from 6 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxy group, a cyano group, a sulfonyl group, an thioalkyl group having from 1 to 12 carbon atoms and an thioaryl group having from 6 to 12 carbon atoms. Z₁₁⁻ represents a monovalent anion. Specific examples of the monovalent anion include a halogen ion, a perchlorate ion, a hexafluorophosphate ion, a tetrafluoroborate ion, a sulfonate ion, a sulfinate ion, a thosulfonate ion and a sulfate ion. Among them, the perchlorate ion, hexafluorophosphate ion, tetrafluoroborate ion, sulfonate ion and sulfinate ion are preferred in view of stability.

In the formula (RI-II), Ar₂₁ and Ar₂₂ each independently represents an aryl group having 20 or less carbon atoms, which may have 1 to 6 substituents. Preferred example of the substituent includes an alkyl group having from 1 to 12 carbon atoms, an alkenyl group having from 2 to 12 carbon atoms, an alkynyl group having from 2 to 12 carbon atoms, an aryl group having from 6 to 12 carbon atoms, an alkoxy group having from 1 to 12 carbon atoms, an aryloxy group having from 6 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxy group, a cyano group, a sulfonyl group, an thioalkyl group having from 1 to 12 carbon atoms and an thioaryl group having from 6 to 12 carbon atoms. Z₂₁⁻ represents a monovalent anion. Specific examples of the monovalent anion include a halogen ion, a perchlorate ion, a hexafluorophosphate ion, a tetrafluoroborate ion, a sulfonate ion, a sulfinate ion, a thosulfonate ion, a sulfate ion and a carboxylate ion. Among them, the perchlorate ion, hexafluorophosphate ion, tetrafluoroborate ion, sulfonate ion, sulfinate ion and carboxylate ion are preferred in view of stability and reactivity.

In the formula (RI-III), R₃₁, R₃₂ and R₃₃ each independently represents an aryl group, alkyl group, alkenyl group or alkynyl group having 20 or less carbon atoms, which may have 1 to 6 substituents. Among them, the aryl group is preferred in view of reactivity and stability.

Preferred example of the substituent includes an alkyl group having from 1 to 12 carbon atoms, an alkenyl group having from 2 to 12 carbon atoms, an alkynyl group having from 2 to 12 carbon atoms, an aryl group having from 6 to 12 carbon atoms, an alkoxy group having from 1 to 12 carbon atoms, an aryloxy group having from 6 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxy group, a cyano group, a sulfonyl group, an thioalkyl group having from 1 to 12 carbon atoms and, an thioaryl group having from 6 to 12 carbon atoms. Z₃₁⁻ represents a monovalent anion. Specific examples of the monovalent anion include a halogen ion, a perchlorate ion, a hexafluorophosphate ion, a tetrafluoroborate ion, a sulfonate ion, a sulfinate ion, a thosulfonate ion, a sulfate ion and a carboxylate ion. Among them, the perchlorate ion, hexafluorophosphate ion, tetrafluoroborate ion, sulfonate ion, sulfinate ion and carboxylate ion are preferred in view of stability and reactivity. As the anion, carboxylate ions described in JP-A-2001-343742 are more preferred, and carboxylate ions described in JP-A-2002-148790 are particularly preferred.

Specific examples of the onium salt are set forth below, but the invention should not be construed as being limited thereto.

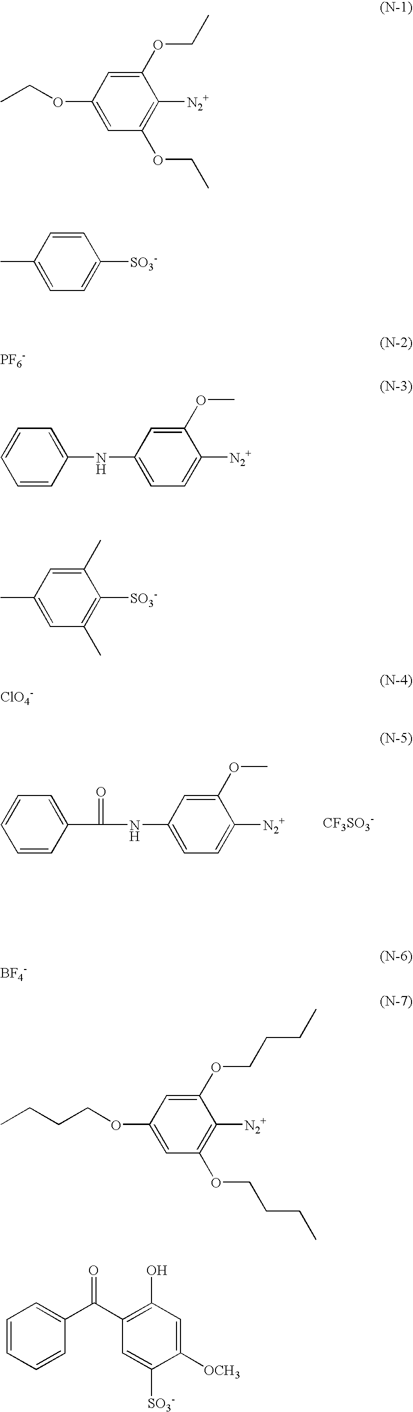

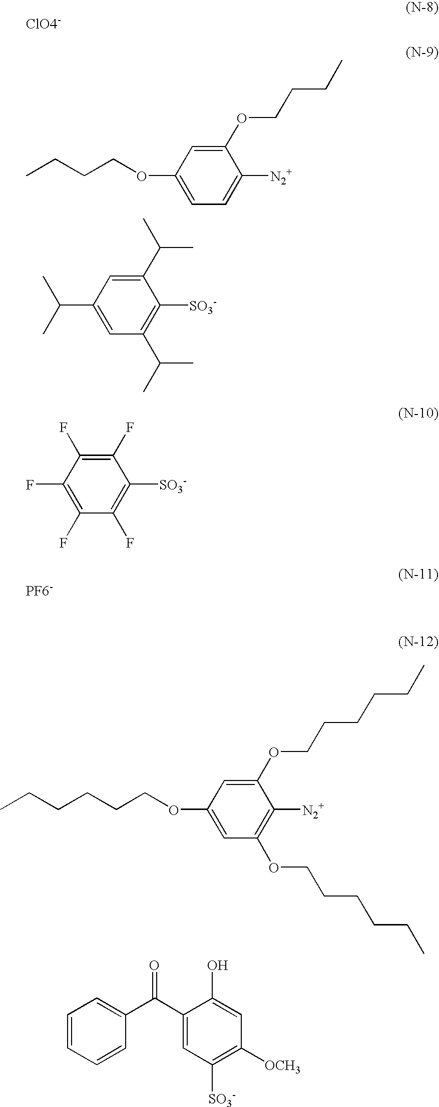

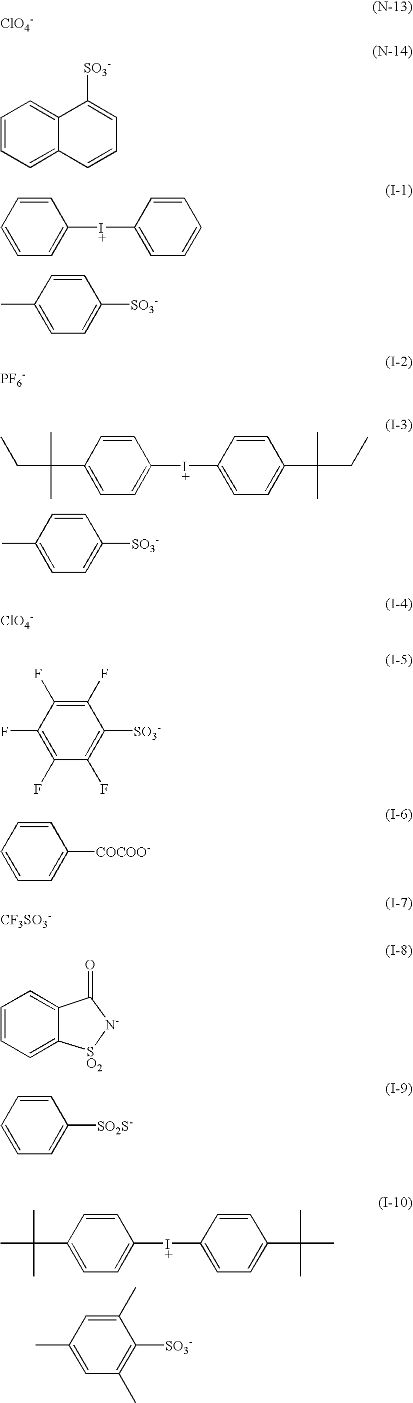

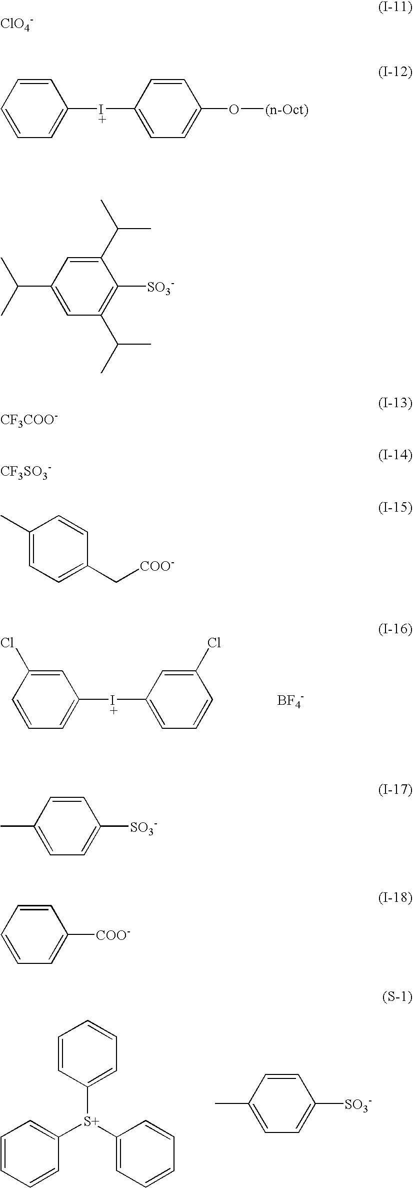

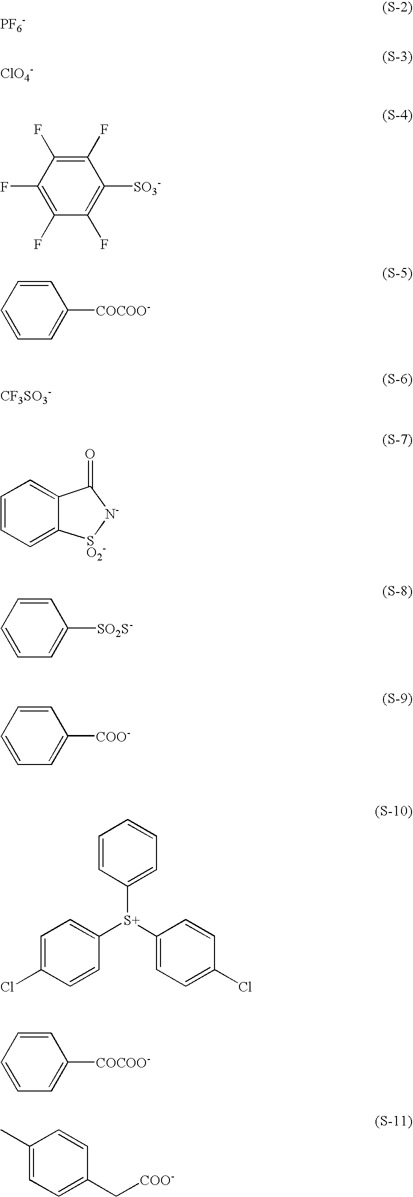

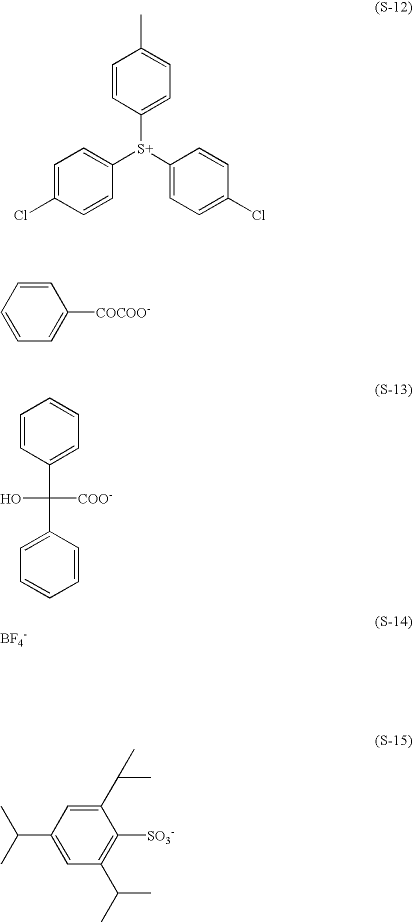

The polymerization initiator is not limited to those described above. The organic halogen compounds, oximester compounds, diazonium salts, iodonium salts and sulfonium salts are more preferred particularly in view of reactivity and stability.

The polymerization initiator can be added preferably in an amount of from 0.1 to 50% by weight, more preferably from 0.5 to 30% by weight, particularly preferably from 0.8 to 20% by weight, based on the total solid content of the image-recording layer. In the above-described range, favorable sensitivity and good stain resistance in the non-image area at the time of printing are achieved. The polymerization initiators may be used individually or in combination of two or more thereof. Further, the polymerization initiator may be added together with other components to one layer or may be added to a different layer separately provided.

<(C) Binder Polymer>

The image-recording layer for use in the lithographic printing plate precursor of the invention contains (C) a lipophilic binder polymer substantially not containing an acid group. The binder polymer is used for the purpose of improving the film strength, film-forming property and on-machine development property of the image-recording layer. It is effective for improvement in the preservation stability of lithographic printing plate precursor that the binder polymer does not contain an acid group. Further, it contributes to the improvement in the solubility or dispesibility in oily ink and the on-machine development property that the binder polymer is lipophilic.

As the binder polymers, those heretofore known can be used without restriction as long as they do not substantially contain an acid group, and linear organic polymers having film forming property are preferred.

Examples of the binder polymer include acrylic resins, polyvinyl acetal resins, polyurethane resins, polyurea resins, polyimide resins, polyamide resins, epoxy resins, methacrylic resins, polystyrene resins, novolac type phenolic resins, polyester resins, synthesis rubbers and natural rubbers.

The binder polymer preferably has a crosslinkability in order to improve the film strength of the image area. The binder polymer can be provided with the crosslinkability by introducing the crosslinking functional group, for example, an ethylenically unsaturated bond, into the main chain or side chain of polymer. The crosslinking functional group may also be introduced by copolymerization.

Examples of the polymer having an ethylenically unsaturated bond in the main chain thereof include poly-1,4-butadiene and poly-1,4-isoprene.

Examples of the polymer having an ethylenically unsaturated bond in the side chain thereof include a polymer of an ester or amide of acrylic acid or methacrylic acid, which is a polymer wherein the ester or amide residue (R in —COOR or —CONHR) has an ethylenically unsaturated bond.

Examples of the residue (R described above) having an ethylenically unsaturated bond include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and —(CH₂CH₂O)₂—X (wherein R¹ to R³ each represents a hydrogen atom, a halogen atom or an alkyl group having from 1 to 20 carbon atoms, an aryl group, alkoxy group or aryloxy group, or R¹ and R² or R¹ and R³ may be combined with each other to form a ring. n represents an integer of from 1 to 10. X represents a dicyclopentadienyl residue).

Specific examples thereof for the ester residue include —CH₂CH═CH₂ (described in JP-B-7-21633) —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue).

Specific examples thereof for the amide residue include —CH₂CH═CH₂, —CH₂CH₂—Y (wherein Y represents a cyclohexene residue) and —CH₂CH₂—OCO—CH═CH₂.

The binder polymer having crosslinkability is hardened, for example, by adding a free radical (a polymerization initiating radical or a propagating radical formed during the polymerization of polymerizable compound) to the crosslinking functional group of the polymer and undergoing addition polymerization between the polymers directly or through a polymerization chain of the polymerizable compounds to form crosslinkage between the polymer molecules. Alternately, it is hardened by generation of a polymer radical upon extraction of an atom in the polymer (for example, a hydrogen atom on a carbon atom adjacent to the functional crosslinking group) by a free radial and connecting the polymer radicals to each other to form cross-linkage between the polymer molecules.

A content of the crosslinking group in the binder polymer (content of the radical polymerizable unsaturated double bond determined by iodine titration) is preferably from 0.1 to 10.0 mmol, more preferably from 1.0 to 7.0 mmol and most preferably from 2.0 to 5.5 mmol, based on 1 g of the binder polymer. In the above-described range, favorable sensitivity and good preservation stability can be obtained.

A weight average molecular weight of the binder polymer is preferably 5,000 or more, more preferably from 10,000 to 300,000. A number average molecular weight of the binder polymer is preferably 1,000 or more, more preferably from 2,000 to 250,000. Polydispersity (weight average molecular weight/number average molecular weight) is preferably from 1.0 to 10.

The binder polymer may be any of a random polymer, a block polymer, a graft polymer and the like, and preferably a random polymer.

The binder polymer can be synthesized by a conventionally known method. A solvent used for the synthesis thereof include, for example, tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propylacetate, N,N-dimethylformamide, N,N-dimethylacetoamnide, toluene, ethyl acetate, methyl lactate, ethyl lactate, dimethylsulfoxide and water. The solvents may be used individually or as a mixture of two or more thereof.

As a radical polymerization initiator used for the synthesis of binder polymer, a known compound, for example, an azo-type initiator or a peroxide initiator call be employed.

The binder polymers may be used individually or as a mixture of two or more thereof.

A content of the binder polymer is preferably, from 10 to 90% by weight, more preferably from 20 to 80% by weight, and still more preferably from 30 to 70% by weight, based on the total solid content of the image-recording layer. In the above-described range, favorable strength of the image area and good imageforming property can be obtained.

It is preferred that (B) the polymerizable compound having the specific structure and (C) the binder polymer are used in a weight ratio of from 1/9 to 7/3.

<(D) Light to Heat Converting Agent>

In the case of using the lithographic printing plate precursor of the invention as a lithographic printing plate precursor sensitive to an infrared laser, it is preferred that a light to heat converting agent is incorporated into the image-recording layer. The light to heat converting agent has a function of converting an infrared ray absorbed to heat. The light to heat converting agent for use in the invention includes a dye or pigment having absorption in a wavelength region of from 760 to 1,200 nm and a dye or pigment ordinarily referred to as an infrared absorbing agent. The infrared absorbing agent used in the invention preferably has an absorption maximum in a wavelength region of from 760 to 1,200 nm.

As the dye, commercially available dyes and known dyes described in literatures, for example, Senryo Binran (Dye Handbook) compiled by The Society of Synthetic Organic Chemistry, Japan (1970) can be used. Specifically, the dyes includes azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal thiolate complexes.

Examples of preferred dye include cyanine dyes described, for example, in JP-A-58-125246, JP-A-59-84356 and JP-A-60-78787; methine dyes described, for example, in JP-A-58-173696, JP-A-58-181690 and JP-A-58-194595; naphthoquinone dyes described, for example, in JP-A-58-112793, JP-A-58-224793, JP-A-5948187, JP-A-59-73996, JP-A-60-52940 and JP-A-60-63744; squarylium dyes described, for example, in JP-A-58-112792; and cyanine dyes described, for example, in British Patent 434,875.

Also, near infrared absorbing sensitizers described in U.S. Pat. No. 5,156,938 are preferably used. Further, substituted arylbenzo(thio)pyrylium salts described in U.S. Pat. No. 3,881,924, trimethinethiapyrylium salts described in JP-A-57-142645 (corresponding to U.S. Pat. No. 4,327,169), pyrylium compounds described in JP-A-58-181051, JP-A-58-220143, JP-A-59-41363, JP-A-59-84248, JP-A-59-84249, JP-A-59-146063 and JP-A-59-146061, cyanine dyes described in JP-A-59-216146, pentamethinethiopyrylium salts described in U.S. Pat. No. 4,283,475, and pyrylium comounds described in JP-B-5-13514 and JP-B-5-19702 are also preferably used. Other preferred examples of the dye include near infrared absorbing dyes represented by formulae (I) and (II) of U.S. Pat. No. 4,756,993.

Other preferred examples of the infrared absorbing dye according to the invention include specific indolenine cyanine dyes described in JP-A-2002-278057 as illustrated below.

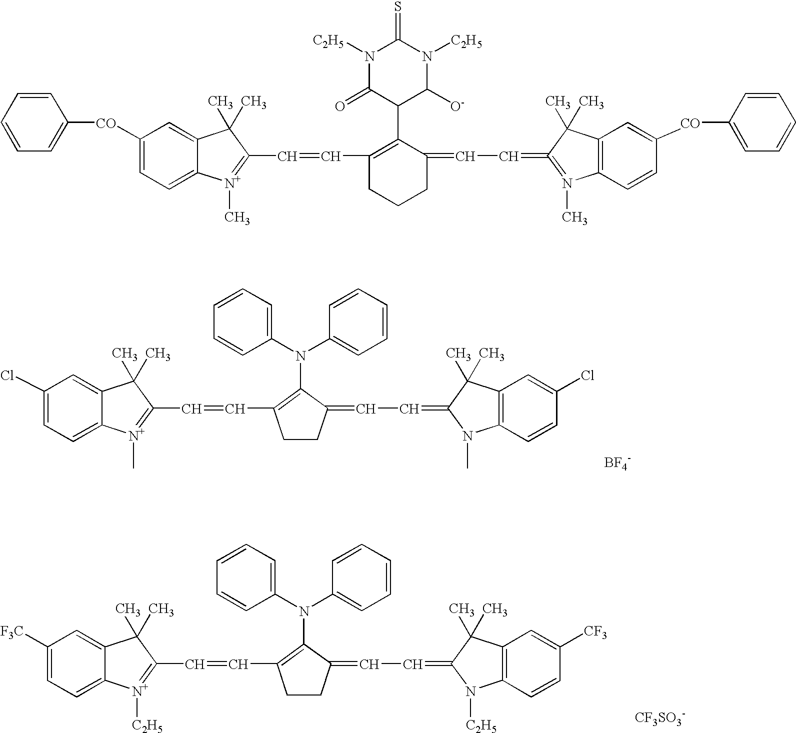

Of the dyes, cyanine dyes, squarylium dyes, pyrylium dyes, nickel thiolate complexes and indolenine cyanine dyes are particularly preferred. Further, cyanine dyes and indolenine cyanine dyes are preferred. As a particularly preferred example of the dye, a cyanine dye represented by the following formula (I) is exemplified.

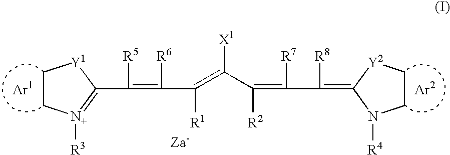

In formula (I), X¹ represents a hydrogen atom, a halogen atom, —NPh₂, X²-L¹ or a group shown below: 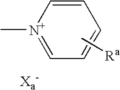
wherein Xa⁻ has the same meaning as Za⁻ defined hereinafter, and R^{a} represents a hydrogen atom, an alkyl group, an aryl group, a substituted or unsubstituted amino group or a halogen atom.

X² represents an oxygen atom, a nitrogen atom or a sulfur atom, L¹ represents a hydrocarbon group having from 1 to 12 carbon atoms, an aromatic ring containing a hetero atom or a hydrocarbon group having from 1 to 12 carbon atoms and containing a hetero atom. The hetero atom indicates a nitrogen atom, a sulfur atom, an oxygen atom, a halogen atom or a selenium atom.

R¹ and R² each independently represents a hydrocarbon group having from 1 to 12 carbon atoms. In view of the preservation stability of a coating solution for image, recording layer, it is preferred that R¹ and R² each represents a hydrocarbon group having two or more carbon atoms, and particularly preferably, R¹ and R² are combined with each other to form a 5-membered or 6-membered ring.

Ar¹ and Ar², which may be the same or different, each represents an aromatic hydrocarbon group, which may have a substituent. Preferred examples of the aromatic hydrocarbon group include a benzene ring and a naphthalene ring. Also, preferred examples of the substituent include a hydrocarbon group having 12 or less carbon atoms, a halogen atom and an alkoxy group having 12 or less carbon atoms. Y¹ and Y², which may be the same or different, each represents a sulfur atom or a dialkylmethylene group having 12 or less carbon atoms. R³ and R⁴, which may be the same or different each represents a hydrocarbon group having 20 or less carbon atoms, which may have a substituent. Preferred examples of the substituent include an alkoxy group having 12 or less carbon atoms, a carboxy group and a sulfo group. R⁵, R⁶, R⁷ and R⁸, which may be the same or different, each represents a hydrogen atom or a hydrocarbon group having 12 or less carbon atoms. In view of the availability of raw materials, a hydrogen atom is preferred. Za⁻ represents a counter anion. However, Za⁻ is not necessary when the cyanine dye represented by formula (I) has an anionic substituent in the structure thereof and neutralization of charge is not needed. Preferred examples of the counter ion for Za⁻ include a halogen ion, a perchlorate ion, a tetrafluoroborate ion, a hexafluorophosphate ion and a sulfonate ion, and particularly preferred examples thereof include a perchlorate ion, a hexafluorophosphate ion and an arylsulfonate ion in view of the preservation stability of a coating solution for image-recording layer.

Specific examples of the cyanine dye represented by formula (I), which can be preferably used in the invention, include those described in paragraph Nos. [0017] to [0019] of JP-A-2001-133969.

Further, other particularly preferred examples include specific indolenine cyanine dyes described in JP-A-2002-278057 described above.

Examples of the pigment used in the invention include commercially available pigments and pigments described in Colour Index (C.I.), Saishin Ganryo Binran (Handbook of the Newest Pigments) compiled by Pigment Technology Society of Japan (1977), Saishin Ganryo Oyou Gijutsu (Newest Application on Technologies for Pigments), CMC Publishing Co., Ltd. (1986) and Insatsu Ink Gijutsu (Printing Ink Technology), CMC Publishing Co., Ltd. (1984).

Examples of the pigment include black pigments, yellow pigments, orange pigments, brown pigments, red pigments, purple pigments, blue pigments, green pigments, fluorescent pigments, metal powder pigments and polymer-bonded dyes. Specific examples of usable pigments include insoluble azo pigments, azo lake pigments, condensed azo pigments, chelated azo pigments, phthalocyanine pigments, anthraquinone pigments, perylene and perynone pigments, thioindigo pigments, quinacridone pigments, dioxazine pigments, isoindolinone pigments, quinophthalone pigments, dying lake pigments, azine pigments, nitroso pigments, nitro pigments, natural pigments, fluorescent pigments, inorganic pigments and carbon black. Of the pigments, carbon black is preferred.

The pigment may be used without undergoing surface treatment or may be used after the surface treatment. For the surface treatment, a method of coating a resin or wax on the surface, a method of attaching a surfactant and a method of bonding a reactive substance (for example, a silane coupling agent, an epoxy compound or polyisocyanate) to the pigment surface. The surface treatment methods are described in Kinzoku Sekken no Seishitsu to Oyo (Properties and Applications of Metal Soap), Saiwai Shobo, Insatsu Ink Gijutsu (Printing Ink Technology), CMC Publishing Co., Ltd. (1984), and Saishin Ganryo Oyo Gijutsu (Newest Application on Technologies for Pigments), CMC Publishing Co., Ltd. (1986).

The pigment has a particle size of preferably from 0.01 to 10 μm, more preferably from 0.05 to 1 μm, particularly preferably from 0.1 to 1 μm. In the above-described range, good stability of the pigment dispersion in a coating solution for image-recording layer and good uniformity of the image-recording layer can be obtained.

For dispersing the pigment, a known dispersion technique for use in the production of ink or toner may be used. Examples of the dispersing machine include an ultrasonic dispersing machine, a sand mill, an attritor, a pearl mill, a super-mill, a ball mill, an impeller, a disperser, a KD mill, a colloid mill, a dynatron, a three roll mill and a pressure kneader. The dispersing machines are described in detail in Saishin Ganryo Oyo Gijutsu (Newest Application on Technologies for Pigments), CMC Publishing Co., Ltd. (1986).

The light to heat converting agent may be added together with other components to one layer or may be added to a different layer separately provided. The light to heat converting agent may also be added by being incorporated into microcapsules.

With respect to an amount of the light to heat converting agent added, in the case of preparing a lithographic printing plate precursor, the amount is so controlled that absorbance of the image-recording layer at the maximum absorption wavelength in the wavelength region of from 760 to 1,200 nm measured by reflection measurement is preferably in a range of from 0.3 to 1.2, more preferably in a range of from 0.4 to 1.1. In the above-described range, the polymerization reaction proceeds uniformly in the thickness direction of the image-recording layer and good film strength of the image area and good adhesion of the image area to a support are achieved.

The absorbance of the image-recording layer can be controlled according to the amount of the infrared absorbing agent added to the image-recording layer and the thickness of the image-recording layer. The measurement of the absorbance can be carried out in a conventional manner. The method for measurement includes, for example, a method of forming an image-recording layer having a thickness determined appropriately in the range necessary for the lithographic printing plate precursor on a reflective support, for example, an aluminum plate, and measuring reflection density of the image-recording layer by an optical densitometer or a spectrophotometer according to a reflection method using an integrating sphere.

<(E) Microcapsule>

In the invention, in order to incorporate the above-descried constituting components (A) to (D) for the image-recording layer and other components described hereinafter into the image-recording layer, all or a part of the constituting components can be encapsulated in microcapsule to be contained in the image-recording layer. The same component can also be present both inside and outside the microcapsule.

In order to achieve the good on-machine development property, it is preferred that the image-recording layer contains the microcapsule. As the component encapsulated, a hydrophobic or oleophilic compound is preferred,

As a method of microencapsulating the constituting components of the image-recording layer, known methods can be used. Methods of manufacturing microcapsules include, for example, a method of utilizing coacervation described in U.S. Pat. Nos. 2,800,457 and 2,800,458, a method of using interfacial polymerization described in U.S. Pat. No. 3,287,154, JP-B-38-19574 and JP-B-42-446, a method of using deposition of polymer described in U.S. Pat. Nos. 3,418,250 and 3,660,304, a method of using an isocyanate polyol wall material described in U.S. Pat. No. 3,796,669, a method of using an isocyanate wall material described in U.S. Pat. No. 3,914,511, a method of using a urea-formaldehyde-type or urea-fonnaldeliyde-resorcinol-type wall material described in U.S. Pat. Nos. 4,001,140, 4,087,376 and 4,089,802, a method of using a wall material, for example, a melamine-formaldehyde resin or hydroxycellulose described in U.S. Pat. No. 4,025,445, an in-situ method by monomer polymerization described in JP-B-36-9163 and JP-B-51-9079, a spray drying method described in British Patent 930,422 and U.S. Pat. No. 3,111,407, and an electrolytic dispersion cooling method described in British Patents 952,807 and 967,074, but the invention should not be construed as being limited thereto.

A preferred microcapsule wall used in the invention has three-dimensional crosslinking and has a solvent-swellable property. From this point of view, a preferred wall material of the microcapsule includes polyurea, polyurethane, polyester, polycarbonate, polyamide and a mixture thereof and particularly polyurea and polyurethane are preferred. Further, a compound having a crosslinkable functional group, for example, an ethylenically unsaturated bond, capable of being introduced into the binder polymer described above may be introduced into the microcapsule wall.

An average particle size of the microcapsule is preferably from 0.01 to 3.0 μm, more preferably from 0.05 to 2.0 μm and particularly preferably from 0.10 to 1.0 μm. In the above-described range, favorable resolution and good preservation stability can be achieved.

<Other Components of Image-Recording Layer>

The image-recording layer according to the invention may further contain other additives, if desired. Such additives are described below.

<Surfactant>

In the invention, it is preferred to use a surfactant in the image-recording layer in order to promote the on-machine development property at the start of printing and to improve surface property of the layer. The surfactant includes, for example, a nonionic surfactant, an anionic surfactant, a cationic surfactant, an amphoteric surfactant and a fluorine-containing surfactant The surfactants may be used individually or in combination of two or more thereof.

The nonionic surfactant used in the invention is not particular restricted, and those hitherto known can be used. Examples of the nonionic surfactant include polyoxyethylene alkyl ethers, polyoxyethylene alkylphenylethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyetbylene glycerin fatty acid partial esters, fatty acid dietbanolamides, N,N-bis-2-hydroxyalkylamines, polyoxyethylene alkylamines, triethanolamine fatty acid esters, trialylamine oxides, polyethylene glycols, and copolymers of polyethylene glycol and polypropylene glycol.

The anionic surfactant used in the invention is not particularly restricted and those hitherto known can be used. Examples of the anionic surfactant include fatty acid salts, abietic acid salts, hydroxyalkanesulfonic acid salts, alkanesulfonic acid salts, dialkylsulfosuccinic ester salts, straight-chain alkylbenzenesulfonic acid salts, branched alkylbenzenesulfonic acid salts, alkylnaphthalenesulfonic acid salts, alky)phenoxypolyoxy ethylene propylsulfonic acid salts, polyoxyethylene alkylsulfophenyl ether salts, N-methyl-N-oleyltaurine sodium salt, N-alkylsulfosuccinic acid monoamide disodium salts, petroleum sulfonic acid salts, sulfated beef tallow oils, sulfate ester slats of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styrylphenyl ether sulfate ester salts, alkyl phosphate ester salts, polyoxyethylene alkyl ether phosphate ester salts, polyoxyethylene alkyl phenyl ether phosphate ester salts, partially saponified products of styrene/maleic anhydride copolymer, partially saponified products of olefin/maleic anhydride copolymer, and naphthalene sulfonate formal in condensates.

The cationic surfactant used in the invention is not particularly restricted and those hitherto known can be used. Examples of the cationic surfactant include alkylamine salts, quaternary ammonium salts, polyoxyethylene alkyl amine salts, and polyethylene polyamine derivatives.

The amphoteric surfactant used in the invention is not particularly restricted and those hitherto known can be used. Examples of the amphoteric surfactant include carboxybetaines, aminocarboxylic acids, sulfobetaines, aminosulfuric esters, and imidazolines.

In the surfactants described above, the term “polyoxyethylene” can be reworded as “polyoxyalkylene”, for example, polyoxymethylene, polyoxypropylene or polyoxybutylene, and such surfactants can also be used in the invention.

Further, a preferred surfactant includes a fluorine-containing surfactant including a perfluoroalkyl group in its molecule. Examples of the fluorine-containing surfactant include an anionic type, for example, perfluoroalkyl carboxylates, perfluoroalkyl sulfonates and perfluoroalkylphosphates; an amphoteric type, for example, perfluoroalkyl betaines; a cationic type, for example, perfluoroalkyl trimethyl ammonium salts, and a nonionic type, for example, perfluoroalkyl amine oxides, petfluoroalkyl ethylene oxide adducts, oligomers having a perfluoroalkyl group and a hydrophilic group, oligomers having a perfluoroalkyl group and an oleophilic group, oligomers having a perfluoroalkyl group, a hydrophilic group and an oleophilic group, and urethanes having a perfluoroalkyl group and an oleophilic group. Moreover, fluorine-containing surfactants described in JP-A-62-170950, JP-A-62-226143 and JP-A-60-168144 are also preferable.

The surfactants may be used individually or in combination of two or more thereof.

A content of the surfactant is preferably from 0.001 to 10% by weight, more preferably from 0.01 to 7% by weight, based on the total solid content of the image-recording layer.

<Hydrophilic Polymer>

In the invention, the image-recording layer may contain a bydrophilic polymer for the purposes of increasing water-absorbing property of the image-recording layer at the on-machine development, improving dispersion stability of the constituting components and improving dispersibility in dampening water at the on-machine development.

The hydrophilic polymer includes, for example, a polymer having a hydrophilic group, for example, a hydroxy group, a carboxyl group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group or a phosphoric acid group.

Specific examples thereof include gum Arabic, casein, gelatin, a starch derivative, carboxy methyl cellulose and a sodium salt thereof, cellulose acetate, sodium alginate, vinyl acetatemaleic acid copolymer, styrene-maleic acid copolymer, polyacrylic acid and a salt thereof, polymethacrylic acid and a salt thereof a homopolymer or copolymer of hydroxyethyl methacrylate, a homopolymer or copolymer of hydroxyethyl acrylate, a homopolymer or copolymer of hydroxypropyl methacrylate, a homopolymer or copolymer of hydroxypropyl acrylate, a homopolymer or copolymer of hydroxybutyl methacrylate, a homopolymner or copolymer of hydroxybutyl acrylate, polyethylene glycol, hydroxypropylene polymer, polyvinyl alcohol, hydrolyzed polyvinyl acetate having hydrolysis degree of 60% by mole or more, preferably 80% by mole or more, polyvinyl formal, polyvinyl butyral, polyvinyl pyrrolidone, a homopolymer or copolymer of acrylamide, a homopolymer or polymer of methacrylamide, a homopolymer or copolymer of N-methylolacrylamide, polyvinyl pyrrolidone, alcohol-soluble nylon, polyether of 2,2-bis-(4-hydroxyphenyl)propane and epichlorohydrin.

A weight average molecular weight of the hydrophilic polymer is preferably from 5,000 or more, more preferably from 10,000 to 300,000. The hydrophilic polymer may be any of a random polymer, a block polymer, a graft polymer and the like.

A content of the hydrophilic polymer in the image-recording layer is preferably from 0.5 to 20% by weight, more preferably from 1 to 10% by weight, based on the total solid content of the image-recording layer.

<Coloring Agent>

In the invention, various compounds other than those described above may be added to the image-recording layer, if desired. For example, a dye having a large absorption in a visible region can be used as a coloring agent of an image in the image-recording layer. Specifically, the dye includes Oil Yellow #101, Oil Yellow #103, Oil Pink #312, Oil Green BG, Oil Blue BOS, Oil Blue #603, Oil Black BY, Oil Black BS, Oil Black T-505 (manufactured by Orient Chemical Industries, Ltd.), Victoria Pure Blue, Crystal Violet (CI42555), Methyl Violet (CI42535), Ethyl Violet, Rhodamine B (CI45170B), Malachite Green (CI42000), Methylene Blue (CI52015) and dyes described in JP-A-62-293247. Further, a pigment, for example, a phthalocyanine pigment, an azo pigment, carbon black or titanium oxide can also preferably be used.

It is preferred to add the coloring agent since distinction between the image area and the non-image area can be easily made after the formation of image. An amount of the coloring agent added is preferably from 0.01 to 10% by weight based on the total solid content of the image-recording layer.

<Printing-Out Agent>

To the image-recording layer according to the invention, a compound causing change in color by an acid or a radical can be added in order to form a print-out image. As such a compound, various kinds of dyes, for example, dyes of diphenylmethane type, tiphenylmethane type, thiazine type, oxazine type, xanthene type, anthraquinone type, iminoquinone type, azo type and azomethine type are effectively used.

Specific examples thereof include dyes, for example, Brilliant Green, Ethyl Violet, Methyl Green, Crystal Violet, Basic Fuchlsine, Methyl Violet 2B, Quinaldine Red, Rose Bengal, Methanyl Yellow, Thimol Sulfophthalein, Xylenol Blue, Methyl Orange, Paramethyl Red, Congo Red, Benzo Purpurin 4B, α-Naphthyl Red, Nile Blue 2B, Nile Blue A, Methyl Violet, Malachite Green, Parafuchsine, Victoria Pure Blue BOH (manufactured by Hodogaya Chemical Co., Ltd.), Oil Blue #603 (manufactured by Orient Chemical Industries, Ltd.), Oil Pink #312 (manufactured by Orient Chermical Industries, Ltd.), Oil Red 5B (manufactured by Orient Chemical Industries, Ltd.), Oil Scarlet #308 (manufactured by Orient Chemical Industries, Ltd), Oil Red OG (manufactured by Orient Chemical Industries, Ltd.), Oil Red RR (manufactured by Orient Chemical Industries, Ltd.), Oil Green #502 (manufactured by Orient Chemical Industries, Ltd.), Spiron Red BEH special (manufactured by Hodogaya Chemical Co., Ltd.), m-Cresol Purple, Cresol Red, Rhodamine B, Rhodamine 6G, Sulfo Rhodamine B, Auramine, 4-p-diethylaminophenyliminonaphthoquione, 2-carboxyanilino-4-p-diethylaminophenyliminonaplithoquinone, 2-carboxystearylamino-4p-N,N-bis(hydroxyethyl)aminophenyliminonaphthoquinone, 1-phenyl-3-methyl-4-p-diethylaminophenylimino-5-pyrazolon and 1-β-naphtyl-4-p-dietbylaminophenylimino-5-pyrazolon, and leuco dyes, for example, p, p′, p″-hexamethyltrinaminotriphenylmethane (leuco Crystal Violet) and Pergascript Blue SRB (manufactured by Ciba Geigy Ltd.].

In addition to those described above, a leuco dye known as a material for heat-sensitive paper or pressure-sensitive paper is also preferably used. Specific examples thereof include, Crystal Violet lactone, Malachite Green lactone, benzoyl leuco Methylene Blue, 2-(N-pheny)-N-methylamino)-6-(N-p-tolyl-N-ethyl)aminofluoran, 2-anilino-3-methyl-6-N-ethyl-p-tolidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N-N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylanino)-7-(4-chloroanilino)fluoran, 3-(N,N-diethylamino)-7-chlorofluoran, 3-(N,N-diethylamiino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-pipelidino-6-methyl-7-anilinofluoran, 3-pyrolidino-6-metlyl-7-anilinofluoran, 3,3-bis(1-ethyl-2-methylindol-3-yl)phthalide, 3,3-bis(1-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-phthalide and 3-(4-diethylaminophenyl)-3-(1-ethyl-2-methylindol-3-yl)phthalide.

A preferred amount of the dye causing change in color by an acid or radical added is from 0.01 to 15% by weight based on the total solid content of the image-recording layer.

<Thermal Polymerization Inhibitor (Polymerization Inhibitor)>

It is preferred to add a small amount of a thermal polymerization inhibitor to the image-recording layer according to the invention in order to prevent undesirable thermal polymerization of the radical polymerizable compound during the production or preservation of the image-recording layer.

The thermal polymerization inhibitor preferably includes, for example, hydroquinone, p-methoxyphenol, di-tert-butyl-p-cresol, pyrogallol, tert-butylcatechol, benzoquinone, 4,4′-thiobis(3-methyl-6-tert-butylphenol), 2,2′-methylenebis(4-methyl-6-tert-butylphenol) and N-nitroso-N-phenylhydroxylamine aluminum salt.

An amount of the thermal polymerization inhibitor added is preferably from about 0.01 to about 5% by weight based on the total solid content of the image-recording layer.

<Higher Fatty Acid Derivative>

To the image-recording layer according to the invention, a higher fatty acid derivative, for example, behenic acid or behenic acid amide may be added to localize on the surface of the image-recording layer during a drying step after coating in order to prevent inhibition of polymerization due to oxygen. An amount of the higher fatty acid derivative added is preferably from about 0.1 to about 10 by weight based on the total solid content of the image-recording layer.

<Plasticizer>

The image-recording layer according to the invention may also contain a plasticizer in order to improve the on-machine development property.

The plasticizer preferably includes, for example, a phthalate ester, e.g., diemthylphthalate, diethylphthalate, dibutylphthalate, diisobutylphthalate, dioctylphthalate, octylcaprylphthalate, dicyclohexylphthalate, ditridecylphthalate, butylbenzylphthalate, diisodecylphthalate or diallylphthalate; a glycol ester, e.g., dimethylglycolphthalate, ehtylphtarylethylglycolate, methylphtharylethylglycolate, butylphtharylbutylglycolate or triethylene glycol dicaprylate ester; a phosphate ester, e.g., tricresylphosphate or triphenylphosphate; an aliphatic dibasic acid ester, e.g., diisobutyladipate, dioctyladipate, dimethylsebacate, dibutylsebacate, dioctylazelate or dibutylmaleate; polyglycidylmethacrylate, triethyl citrate, glycerin triacetyl ester and butyl laurate.

A content of the plasticizer is preferably about 30% by weight or less based on the total solid content of the image-recording layer.

<Fine Inorganic Particle>

The image-recording layer according to the invention may contain fine inorganic particle in order to increase the hardened film strength of the image area and to improve the on-machine development property of the non-imaging area.

The fine inorganic particle preferably includes, for example, silica, alumina, magnesium oxide, titanium oxide, magnesium carbonate, calcium alginate and a mixture thereof. Even if the fine inorganic particle has no light to heat converting property, it can be used, for example, for strengthening the film or enhancing interface adhesion due to surface roughening.

The fine inorganic particle preferably has an average particle size of from 5 nm to 10 μm and more preferably from 0.5 to 3 μm. In the above-described range, it is stably dispersed in the image-recording layer, sufficiently maintains the film strength of the image-recording layer and can form the non-imaging area excellent in hydrophilisity and preventing from stain at printing.

The fine inorganic particle described above is easily available as a commercial product, for example, colloidal silica dispersion.

A content of the fine inorganic particle is preferably 20% by weight or less and more preferably 10% by weight or less based on the total solid content of the image-recording layer.

<Low Molecular Hydrophilic Compound>

The image-recording layer according to the invention may contain a hydrophilic low molecular compound in order to improve the on-machine developing property. The hydrophilic low molecular compound includes water soluble organic compounds, for example, a glycol compound, e.g., ethylene glycol, diethylene glycol, triethylene glycol, propylene glycol, dipropylene glycol, tripropylene glycol, or an ether or ester derivative thereof, a polyhydroxy compound, e.g., glycerine or pentaerythlitol, an organic amine or a salt thereof, e.g., triethanol amine, diethanol amine, monoethanol amine, an organic sulfonic acid or a salt thereof, eg., toluene sulfonic acid or benzene sulfonic acid, an organic phosphonic acid or a salt thereof, e.g., phenyl phosphonic acid, an organic carboxylic acid or a salt thereof, e.g., tartaric acid, oxalic acid, citric acid, maleic acid, lactic acid, gluconic acid or an amino acid.

<Sensitizer>

The image-recording layer according to the invention may contain a sensitizer. When the sensitizer is used in combination with the above-described radical polymerization initiator, the photopolymerization rate can be increased, and it is particularly effective in a lithographic printing plate precursor sensitive to UV laser.

Specific examples of the sensitizer include benzoin, benzoin methyl ether, benzoin ethyl ether, 9-fluorenone, 2-chloro-9-fluorenone, 2-methyl-9-fluorenone, 9-anthrone, 2-bromo-9-anthrone, 2-ethyl-9-anthrone, 9,10-anthraquinone, 2-ethyl-9,10-anthraquinone, 2-tert-butyl-9,10-anthraquinone, 2,6-dichloro-9,10-anthraquinone, xantone, 2-methylxantone, 2-methoxyxantone, thioxantone, benzyl, dibenzalacetone, p-(dimethylamino)phenyl styryl ketone, p-(dimethylamino)phenyl p-methylstyryl ketone, benzophenone, p-(dimethylamino)benzophenone (or Michler's ketone), p-(diethylamino)benzophenone and benzanthrone.

Further, preferred examples of the sensitizer used in the invention include a compound represented by formula (II) described in JP-B-51-48516.

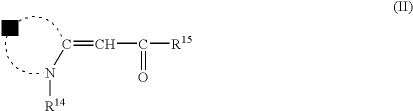

In the formula, R¹⁴ represents an alkyl group (for example, a methyl group, an ethyl group or a propyl group) or a substituted alkyl group (for example, a 2-hydroxyethyl group, a 2-methoxyethyl group, a carboxymethyl group or a 2-carboxyethyl group). R¹⁵ represents an alkyl group (for example, a methyl group or an ethyl group) or an aryl group (for example, a phenyl group, a p-hydroxyphenyl group, a naphthyl group or a thienyl group).

Z² represents a nonmetallic atomic group necessary for forming a nitrogen-containing heterocyclic nucleus conventionally used in a cyanine dye, for example, a benzothiazole (e.g., benzothiazole, 5-chlorobenzothiazole or 6-chlorobenzothiazole), a naphthothiazole (e.g., α-naphthothiazole or β-naphthothiazole), a benzoselenazole (e.g., benzoselenazole, 5-chlorobenzoselenazole or 6-methoxybenzoselenazole), a naphthoselenazole (e.g., α-naphthoselenazole or β-naphthoselenazole), a benzoxazole (e.g., benzoxazole, 5-methylbenzoxazole or 5-phenylbenzoxazole) or a naphthoxazole (e.g., α-naphthoxazole or β-naphthoxazole).

Specific examples of the compound represented by formula (II) include compounds having a chemical structure of a combination of Z², R¹⁴ and R¹⁵, and many compounds are present as known substances. Thus, the compound used can be appropriately selected from known substances. Moreover, preferred examples of the sensitizer used in the invention include merocyanine dyes described in JP-B-5-47095 and a ketocoumalin compound represented by the following formula (III): 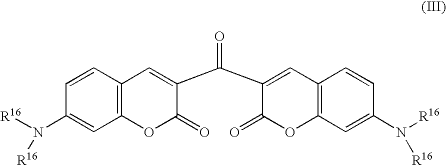
wherein R¹⁶ represents an alkyl group, for example, a methyl group or an ethyl group.

Furthermore, merocyanine dyes described in JP-A-2000-147763 are also used as the sensitizer.

The sensitizer can be added in an amount of preferably from 0.1 to 50% by weight, more preferably from 0.3 to 30% by weight, particularly preferably from 0.8 to 20% by weight, based on the total solid content of the image-recording layer.

<Formation of Image-Recording Layer>

The image-recording layer according to the invention is formed by dispersing or dissolving each of the necessary components described above in a solvent to prepare a coating solution and coating the solution. The solvent used include, for example, ethylene dichloride, cyclohexanone, methyl ethyl ketone, methanol, ethanol, propanol, ethylene glycol monomethyl ether, 1-methoxy-2-propanol, 2-methxyethyl acetat, 1-methoxy-2-propyl acetate, dimethoxyethane, methyl lactate, ethyl lactate, N,N-dimethylacetoamide, N,N-dimethylformamide, tetramethylurea, N-methylpyrrolidone, dimethylsulfoxide, sulfolane, γ-butyl lactone, toluene and water, but the invention should not be construed as being limited thereto. The solvents may be used individually or as a mixture. The solid concentration of the coating solution is preferably from 1 to 50% by weight.

The image-recording layer according to the invention may also be formed by preparing plural coating solutions by dispersing or dissolving the same or different components described above into the same or different solvents and conducting repeatedly coating and drying plural times.

A coating amount of the image-recording layer (solid content) on the support after the coating and drying may be changed depending on the use and ordinarily, it is preferably from 0.3 to 3.0 g/m². In the range above, the favorable sensitivity and good film property of the image-recording layer can be obtained.

Various methods can be used for the coating. Examples of the method include bar coater coating, spin coating, spray coating, curtain coating, dip coating, air knife coating, blade coating and roll coating.

[Support]

The support for use in the lithographic printing plate precursor of the invention is not particularly restricted as long as it is a dimensionally stable plate-like material. The support includes, for example, paper, paper laminated with plastic (for example, polyethylene, polypropylene or polystyrene), a metal plate (for example, aluminum, zinc or copper plate), a plastic film (for example, cellulose diacetate, cellulose triacetate, cellulose propionate, cellulose butyrate, cellulose acetatebutyrate, cellulose nitrate, polyethylene terephthalate, polyethylene, polystyrene, polypropylene, polycarbonate or polyvinyl acetal film) and paper or a plastic film laminated or deposited with the metal described above. A preferred support includes a polyester film and an aluminum plate Among them, the aluminum plate is preferred since it has good dimensional stability and is relatively inexpensive.

The aluminum plate includes a pure aluminum plate, an alloy plate comprising aluminum as a main component and containing a trace amount of hetero elements and a thin film of aluminum or aluminum alloy laminated with plastic The hetero element contained in the aluminum alloy includes, for example, silicon, iron, manganese, copper, magnesium, chromium, zinc, bismuth, nickel and titanium. The content of the hetero element in the aluminum alloy is preferably 10% by weight or less. Although a pure aluminum plate is preferred in the invention, since completely pure aluminum is difficult to be produced in view of the refining technique, the aluminum plate may slightly contain the hetero element. The composition is not specified for the aluminum plate and those materials known and used conventionally can be appropriately utilized.

The thickness of the support is preferably from 0.1 to 0.6 mm, more preferably from 0.15 to 0.4 mm, and still more preferably from 0.2 to 0.3 mm.

Prior to the use of aluminum plate, a surface treatment, for example, roughening treatment or anodizing treatment is preferably performed, The surface treatment facilitates improvement in the hydrophilic property and ensuring of adhesion between the image-recording layer and the support. Prior to the roughening treatment of the aluminum plate, a degreasing treatment, for example, with a surfactant, an organic solvent or an aqueous alkaline solution is conducted for removing rolling oil on the surface thereof, if desired.

The roughening treatment of the surface of the aluminum plate is conducted by various methods and includes, for example, mechanical roughening treatment, electrochemical roughening treatment (roughening treatment of electrochemically dissolving the surface) and chemical roughening treatment (roughening treatment of chemically dissolving the surface selectively).

As the method of the mechanical roughening treatment, a known method, for example, ball grinding, brush grinding, blast grinding or buff grinding can be used.

The electrochemical roughening treatment method includes, for example, a method of conducting by passing alternating current or direct current in an electrolyte containing an acid, for example, hydrochloric acid or nitric acid. Also, a method of using a mixed acid described in JP-A-54-63902 can be used.

The aluminum plate subjected to the roughening treatment is subjected, if desired, to an alkali etching treatment using an aqueous solution, for example, of potassium hydroxide or sodium hydroxide and further subjected to a neutralizing treatment, and then subjected to an anodizing treatment in order to improve the abrasion resistance, if desired.

As the electrolyte used for the anodizing treatment of the aluminum plate, various electrolytes capable of forming porous oxide film can be used. Ordinarily, sulfuric acid, hydrochloric acid, oxalic acid, chromic acid or a mixed acid thereof is used. The concentration of the electrolyte can be appropriately determined depending on the kind of the electrolyte.

Since the conditions of the anodizing treatment are varied depending on the electrolyte used, they cannot be defined commonly. However, it is ordinarily preferred that electrolyte concentration in the solution is from 1 to 80% by weight, liquid temperature is from 5 to 70° C., current density is from 5 to 60 A/dm², voltage is from 1 to 100 V, and electrolysis time is from 10 seconds to 5 minutes. The amount of the anodized film formed is preferably from 1.0 to 5.0 g/m² and more preferably from 1.5 to 4.0 g/m². In the range above, good printing durability and favorable scratch resistance in the non-image area of lithographic printing plate can be achieved.

The aluminum plate subjected to the surface treatment and having the anodized film is used as it is as the support in the invention. However, in order to more improve adhesion to a layer provided thereon, hydrophilisity, resistance to stain, heat insulating property or the like, other treatment, for example, a treatment for enlarging micropores of the anodized film described in JPA-2001-253181 and JP-A-2001-322365, a sealing treatment of micropores or a surface hydrophilizing treatment by immersing in an aqueous solution containing a hydrophilic compound, may be appropriately conducted.

The hydrophilizing treatment includes an alkali metal silicate method described in U.S. Pat. Nos. 2,714,066, 3,181,461, 3,280,734 and 3,902,734. In the method, the support is subjected to immersion treatment or electrolytic treatment in an aqueous solution, for example, of sodium silicate. In addition, hydrophilizing treatment includes, for example, a method of treating with potassium fluorozirconate described in JP-B-36-22063 and a method of treating with polyvinylphosphonic acid described in U.S. Pat. Nos. 3,276,868, 4,153,461 and 4,689,272.

In the case of using a support having insufficient hydrophilisity, for example, a polyester film, in the invention, it is desirable to coat a hydrophilic layer thereon to make the surface sufficiently hydrophilic. The hydrophilic layer preferably includes a hydrophilic layer formed by coating a coating solution containing a colloid of an oxide or hydroxide of at least one element selected from beryllium, magnesium, aluminum, silicon, titanium, boron, germanium, tin, zirconium, iron, vanadium, antimony and a transition metal described in JP-A-2001-199175, a hydrophilic layer containing an organic hydrophilic matrix obtained by crosslinking or pseudo-crosslinking of an organic hydrophilic polymer described in JP-A-2002-79772, a hydrophilic layer containing an inorganic hydrophilic matrix obtained by sol-gel conversion comprising hydrolysis and condensation reaction of polyalkoxysilane and titanate, zirconate or aluminate and a hydrophlic layer comprising an inorganic thin layer having a surface containing metal oxide. Among them, the hydrophilic layer formed by coating a coating solution containing a colloid of an oxide or hydroxide of silicon is preferred.

Further, in the case of using, for example, a polyester film as the support in the invention, it is preferred to provide an antistatic layer on the hydrophilic layer side, opposite side to the hydrophilic layer or both sides. When the antistatic layer is provided between the support and the hydrophilic layer, it also contributes to improve the adhesion of the hydrophilic layer to the support. As the antistatic layer, a polymer layer having fine particles of metal oxide or a matting agent dispersed therein described in JP-A-2002-79772 may be used.

The support preferably has a center line average roughness of from 0.10 to 1.2 μm. In the range, good adhesion with the image-recording layer, good printing durability, and good resistance to stain can be achieved.

Further, color density of the support is preferably from 0.15 to 0.65 in terms of a reflection density value. In the range above, good image-forming property due to prevention of halation at the image exposure and good plate inspection property after development can be achieved.

[Undercoat Layer]

In the lithographic printing plate precursor of the invention, particularly ill the lithographic printing plate precursor of on-machine development type, an undercoat layer is provided between the support and the image-recording layer, if desired. The undercoat layer makes removal of the image-recording layer from the support in the unexposed area easy and the on-machine development property is improved. Further, it is advantageous that in the case of infrared laser exposure, since the undercoat layer acts as a heat insulating layer, heat generated upon the exposure does not diffuse into the support and is efficiently utilized so that increase in sensitivity can be achieved.

As the undercoat layer, specifically, for example, a layer comprising a silane coupling agent having an addition-polymerizable ethylenic double bond reactive group described in JP-A-10-282679 and a layer comprising a phosphorus compound having an ethylenic double bond reactive group described in JP-A-2-304441 are preferably exemplified.

As the most preferred undercoat layer, a layer comprising a polymer resin obtained by copolymerization of a monomer having an adsorbing group, a monomer having a hydrophilic group and a monomer having a crosslinking group is exemplified, The essential component in the polymer undercoat is an adsorbing group to the hydrophilic surface of the support. Whether adsorptivity to the hydrophilic surface of the support is present or not can be judged, for example, by the following method.

A test compound is dissolved in an easily soluble solvent to prepare a coating solution, and the coating solution is coated and dried on a support so as to have the coating amount after drying of 30 mg/m². After thoroughly washing the support coated with the test compound using the easily soluble solvent, the residual amount of the test compound that has not been removed by the washing is measured to calculate the adsorption amount to the support. For measuring the residual amount, the residual amount of the test compound may be determined directly, or may be calculated by determining the amount of the test compound dissolved in the washing solution. The determination for the compound can be performed, for example, by X-ray fluorescence spectrometry, reflection absorption spectrometry or liquid chromatography. The compound having the adsorptivity to support is a compound that remains by 1 mg/m² or more even after conducting the washing treatment described above.

The adsorbing group to the hydrophilic surface of the support is a functional group capable of forming a chemical bond (for example, an ionic bond, a hydrogen bond, a coordinate bond or a bond with intermolecular force) with a substance (for example, metal or metal oxide) or functional group (for example, a hydroxy group) present on the surface of the support. The adsorbing group is preferably an acid group or a cationic group.

The acid group preferably has an acid dissociation constant (pKa) of 7 or less. Examples of the acid group include a phenolic hydroxy group, a carboxyl group, —SO₃H, —OSO₃H, —PO₃H₂, —OPO₃H₂, —CONHSO₂—, —SO₂NHSO₂ and —COCH₂COCH₃. Among them, a phosphoric group (—OPO₃H₂ or —PO₃H₂) is particularly preferred. The acid group may form a metal salt.

The cationic group is preferably an onium group. Examples of the onium group include an ammonium group, a phosphonium group, an arsonium group, a stibonium group, an oxonium group, a sulfonium group, a selenonium group, a stannonium group and iodonium group. Among them, the ammonium group, phosphonium group and sulfonium group are preferred, the ammonium group and phosphonium group are more preferred, and the ammonium group is most preferred.

Particularly preferred examples of the monomer having the functional group include compounds represented by the following formula (IV) or (V):

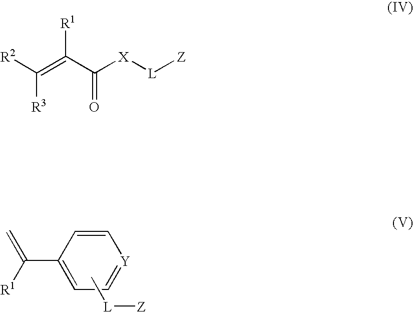

In formulae (IV) and (V), R¹, R² and R³ each independently represents a hydrogen atom, a halogen atom or an alkyl group having from 1 to 6 carbon atoms. R¹, R² and R³ each independently represents preferably a hydrogen atom or an alkyl group having from 1 to 6 carbon atoms, more preferably a hydrogen atom or an alkyl group having from 1 to 3 carbon atoms and, most preferably a hydrogen atom or methyl group. It is particularly preferred that R² and R³ each represents a hydrogen atom.

In the formula (IV), X represents an oxygen atom (—O—) or imino group (—NH—). Preferably, X represents an oxygen atom. In the formulae (IV) and (V), L represents a divalent connecting group. It is preferred that L represents a divalent aliphatic group (for example, an alkylene group, a substituted alkylene group, an alkenylene group, a substituted alkenylene group, an alkinylene group or a substituted alkinylene group), a divalent aromatic group (for example, an arylene group or a substituted arylene group), a divalent heterocyclic group or a combination of each of the groups described above with an oxygen atom (—O—), a sulfur atom (—S—), an imino group (—NH—), a substituted imino group (—NR—, where R represents an aliphatic group, an aromatic group or a heterocyclic group) or a carbonyl group (—CO—).

The aliphatic group may form a cyclic structure or a branched structure. The number of carbon atoms of the aliphatic group is preferably from 1 to 20, more preferably from 1 to 15, and most preferably from 1 to 10. It is preferred that the aliphatic group is a saturated aliphatic group rather than an unsaturated aliphatic group. The aliphatic group may have a substituent. Examples of the substituent include a halogen atom, a hydroxy group, an aromatic group and a heterocyclic group.

The number of carbon atoms of the aromatic group is preferably from 6 to 20, more preferably from 6 to 15 and most preferably from 6 to 10, The aromatic group may have a substituent. Examples of the substituerit include a halogen atom, a liydroxy group, an aliphatic group, an aromatic group and a heterocyclic group.

It is preferred that the heterocyclic group has a five-membered or six-membered ring as the hetero ring. Other heterocyclic ring, an aliphatic ring or an aromatic ring may be condensed to the heterocyclic ring. The heterocyclic group may have a substituent Examples of the substituent include a halogen atom, a hydroxy group, an oxo group (═O), a thioxo group (═S), al imino group (═NH), a substituted imino group (═N—R, where R represents an aliphatic group, an aromatic group or a heterocyclic group), an aliphatic group, an aromatic group and a heterocyclic group.

It is preferred that L represents a divalent connecting group containing a plurality of polyoxyalkylene structures. It is more preferred that the polyoxyalkylene structure is a polyoxyethylene structure. Specifically, it is preferred that L contains —(OCH₂CH₂)ₙ— (n is an integer of 2 or more).

In the formulae (IV) and (V), Z represents a functional group adsorbing on the hydrophilic surface of the support. Y in formula (V) represents a carbon atom or a nitrogen atom. In the case where Y is a nitrogen atom and L is connected to Y to form a quaternary pyridinium group, Z is not mandatory, because the quaternary pyridinium group itself exhibits the adsorptivity.

The absorptive functional group is same as that described above.

Representative examples of the monomer represented by formula (IV) or (V) are set forth below.

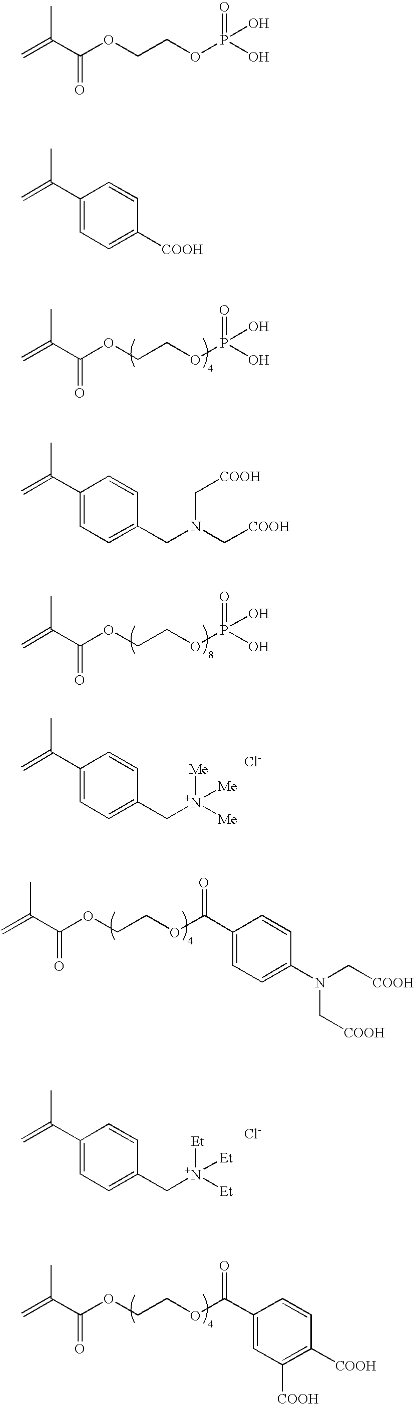

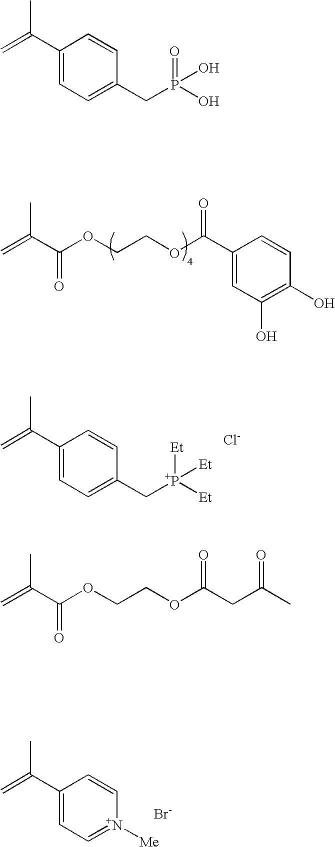

The hydroxy group included in the polymer resin for the undercoat layer for use in the invention preferably includes, for example, a hydroxy group, a carboxy group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group and a phosphoric acid group. A monomer having the hydroxy group and a polymerizable group is employed as a copolymerization component of the above-described polymer resin.

It is preferred that the polymer resin for the undercoat layer for use in the invention has a crosslinking group. The crosslinking group acts to improve the adhesion to the image area. In order to impart the crosslinking property to the polymer resin for the undercoat layer, introduction of a crosslinking functional group, fbr example, an ethylenically unsaturated bond group into the side chain of polymer, or formation of a salt structure between a polar substituent of the polymer resin and a compound containing a substituent having a counter charge and an ethylenically unsaturated bond is used.

Examples of the polymer having an ethylenically unsaturated bond in the side chain thereof include a polymer of an ester or amide of acrylic acid or methacrylic acid, which is a polymer wherein the ester or amide residue (R in —COOR or —CONHR) has an ethylenically unsaturated bond.

Examples of the residue (R described above) having an ethylenically unsaturated bond include —(CH₂)ₙCR₁═CR₂R₃, —(CH₂O)ₙCH₂CR₁═CR₂R₃, —(CH₂CH₂O)ₙCH₂CR₁═CR₂R₃, —(CH₂)ₙNH—CO—O—CH₂CR₁═CR₂R₃, —(CH₂)ₙ—O—CO—CR₁═CR₂R₃ and —(CH₂CH₂O)₂—X (wherein R₁ to R₃ each independently represents a hydrogen atom, a halogen atom or an alkyl group having from 1 to 20 carbon atonms, an aryl group, alkoxy group or aryloxy group, or R₁ and R₂ or R₁ and R₃ may be connected with each other to fonn a ring. n represents an integer of from 1 to 10. X represents a dicyclopentadienyl residue).

Specific examples thereof for the ester residue include —CH₂CH═CH₂ (described in JP-B-7-21633) —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue).

Specific examples thereof for the amide residue include —CH₂CH═CH₂, —CH₂CH₂O—Y (wherein Y represents a cyclohexene residue) and —CH₂CH₂OCO—CH═CH₂.

As a monomer having a crosslinking group for the polymer resin for the undercoat layer, an ester or amide of acrylic acid or methacrylic acid having the crosslinking group is preferred.

A content of the crosslinking group in the polymer resin for the undercoat layer (content of the radical polymerizable unsaturated double bond determined by iodine titration) is preferably from 0.1 to 10.0 mmol, more preferably from 1.0 to 7.0 mmol and most preferably from 2.0 to 5.5 mmol, based on 1 g of the polymer rsin. In the above-described range, favorable compatibility between sensitivity and stain resistance and good preservation stability can be obtained.

A weight average molecular weight of the polymer resin is preferably 5,000 or more, more preferably from 10,000 to 300,000. A number average molecular weight of the polymer resin is preferably 1,000 or more, more preferably from 2,000 to 250,000. Polydispersity (weight average molecular weight/number average molecular weight) is preferably from 1.1 to 10.

The polymer resin may be any of a random polymer, a block polymer, a graft polymer and the like, and preferably a random polymer.

As the polymer resin for the undercoat layer according to the invention, known resins having a hydrophilic group can also be used. Specific examples of such resins include gum Arabic, casein, gelatin, a starch derivative, carboxy methyl cellulose and a sodium salt thereof, cellulose acetate, sodium alginate, vinyl acetate-maleic acid copolymer, styrene-maleic acid copolymer, polyacrylic acid and a salt thereof, polymethacrylic acid and a salt thereof, a homopolymer or copolymer of hydroxyethyl methacrylate, a homopolymer or copolymer of hydroxyethyl acrylate, a homopolymer or copolymer of hydroxypropyl methacrylate, a homopolymer or copolymer of hydroxypropyl acrylate, a homopolymer or copolymer of hydroxybutyl methacrylate, a homopolymer or copolymer of hydroxybutyl acrylate, polyethylene glycol, hydroxypropylene polymer, polyvinyl alcohol, hydrolyzed polyvinyl acetate having hydrolysis degree of 60% by mole or more, preferably 80% by mole or more, polyvinyl formal, polyvinyl butyral, polyvinyl pyrrolidone, a homopolymer or copolymer of acrylamide, a homopolymer or polymer of methacrylamide, a homopolymer or copolymer of N-methylolacrylamide, polyvinyl pyrrolidone, alcohol-soluble nylon, polyether of 2,2-bis-(4-hydroxyphenyl)propane and epichlorohydrin.

The polymer resins for the undercoat layer may be used individually or as a mixture of two or more thereof Two or more of the compounds having the functional group adsorbing to the hydrophilic surface of the support may be used.

The coating amount (solid content) of the undercoat layer is preferably from 0.1 to 100 mg/m², more preferably from 1 to 30 mg/m².

[Back Coat Layer]

After applying the surface treatment or forming the undercoat layer to the support, a back coat layer can be provided on the back surface of the support, if desired.

The back coat layer preferably includes, for example, a coating layer comprising an organic polymer compound described in JP-A-5-45885, and a coating layer comprising a metal oxide obtained by hydrolysis and polycondensation of an organic metal compound or an inorganic metal compound described in JP-A-6-34174. Among them, use of an alkoxy compound of silicon, for example, Si(OCH₃)₄, Si(OC₂H₅)₄, Si(OC₃H₇)₄, or Si(OC₄H₉)₄ is preferred since the starting material is inexpensive and easily available.

[Protective Layer]

In the lithographic printing plate precursor according to the invention for use in the lithographic printing method of the invention, a protective layer may be provided on the image-recording layer, if desired, for the purpose of preventing the occurrence of scratch or the like, blocking oxygen and preventing ablation at the exposure with a laser having high illumination in the image-recording layer.

In the invention, the exposure is ordinarily conducted in the atmosphere, and the protective layer prevents invasion of a low molecular compound that hinders a image-forming reaction initiated by the image exposure in the image-recording layer, for example, oxygen or a basic substance present in the atmosphere thereby preventing the hindrance of the image-forming reaction by the exposure in the atmosphere. Accordingly, characteristics desired to the protective layer preferably include that it has good permeation of light used for exposure, that it is excellent in adhesion to the image-recording layer and that it can be easily removed by the on-machine developing step after the exposure as well as it has low permeability of the low molecular compound, for example, oxygen. The protective layer having such characteristics has been heretofore variously studied and described in detail, for example, in U.S. Pat. No. 3,458,311 and in JP-B-55-49729.

The material used for the protective layer includes, for example, a water-soluble polymer compound of relatively excellent crystallinity. Specifically, it includes a water-soluble polymer, for example, polyvinyl alcohol, polyvinyl pyrrolidone, acidic cellulose, gelatin, gum Arabic and a polyacrylic acid. Among them, the use of polyvinyl alcohol (PVA) as the main component provides the most preferred result for the basic characteristics, for example, oxygen blocking property and removability upon development. The polyvinyl alcohol may be partially substituted with ester, ether or acetal or partially have other copolymerization component as long as it contains unsubstituted vinyl alcohol units necessary for providing the protective layer with the oxygen blocking property and water solubility.

Preferred examples of the polyvinyl alcohol include those having a hydrolysis rate of from 71 to 100% by mole and a polymerization degree ranging from 300 to 2,400. Specific examples thereof include PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA420, PVA613 and L-8 manufactured by Kuraray Co., Ltd.

The component (for example, selection of PVA, use of additive) and the coating amount of the protective layer are appropriately selected in consideration of fog-preventing property, adhesion and scratch resistance as well as the oxygen blocking property and removability upon development. Ordinarily, as the hydrolysis rate of PVA is higher (that is, the content of unsubstituted vinyl alcohol unit present in the protective film is higher) or as the thickness of the protective layer is larger, the oxygen blocking property is enhanced and it is preferred in view of the sensitivity. Further, for preventing occurrence of undesirable polymerization reaction during the production and preservation and preventing undesirable fog and thickening of image line at the image exposure, it is preferred that the oxygen permeability is not excessively high. Accordingly, the oxygen permeability A at 25° C. under 1 atm is preferably as follows: 0.2≦A<20 (cc/m²·day).

As other composition for the protective layer, glycerin, dipropylene glycol, etc. can be added in an amount corresponding to several % by weight of the water-soluble polymer compound to impart flexibility. Further, an anionic surfactant, for example, sodium alkyl sulfate or sodium alkyl sulfonate; an amphoteric surfactant, for example, alkylamino carboxylic acid salt or alkylamino dicarboxylic acid salt; or a non-ionic surfactant, for example, polyoxyethylene alkylphenyl ether can be added by several % by weight to the water-soluble polymer compound.

Further, the adhesion to the image area, scratch resistance, etc. of the protective layer are also extremely important in view of handling of the lithographic printing plate precursor. Specifically, when a protective layer, which is hydrophilic due to the incorporation of the water-soluble polymer compound, is coated on the oleophilic image-recording layer, peeling of the protective layer is apt to occur because of the insufficiency of adhesion and it may sometimes result in defect, for example, poor film hardening caused by inhibition of polymerization due to oxygen.

Various proposals have been made for the purpose of improving the adhesion between the image-recording layer and the protective layer. For example, it is described in JP-A49-70702 and British Patent 1,303,578 that sufficient adhesion can be obtained by mixing from 20 to 60% by weight of an acrylic emulsion, a water-insoluble vinyl pyrrolidone—vinyl acetate copolymer or the like in a hydrophilic polymer mainly comprising polyvinyl alcohol and coating the mixture on the image-recording layer. In the invention, any of the known techniques can be used.

Further, other functions can also be provided to the protective layer. For example, by adding a coloring agent (for example, a water-soluble dye), which is excellent in the transmission of light used for the exposure and capable of efficiently absorbing light at other wavelength, a safe light adaptability can be improved without decreasing the sensitivity.

The thickness of the protective film is preferably from 0.1 to 5 μm, and particularly preferably from 0.2 to 2 μm.

The coating method of the protective layer is described in detail, for example, in U.S. Pat. No. 3,458,311 and JP-B-55-49729.

[Lithographic Printing Method]

In the invention, the image-recording layer formed by coating on the support is exposed through a transparent original having line images, dot images and the like or imagewise exposed based on digital data by a laser beam or the like to provide a negative relief image corresponding to the original. Light source preferably used for the exposure includes, for example, a carbon arc lamp, a mercury lamp, a xenon lamp, a metal halide lamp, a strobe, an ultraviolet ray, an infrared ray and a laser beam. The laser beam is particularly preferred and includes, for example, a solid laser and a semiconductor laser emitting an infrared ray of from 760 to 1,200 nm and a blue-violet semiconductor laser called as a violet laser.

In the lithographic printing method according to the invention, the lithographic printing plate precursor according to the invention is imagewise exposed by a laser as described above and subjected to printing by supplying oily ink and an aqueous ingredient without undergoing any development processing step.

Specifically, for instance, a method wherein the lithographic printing plate precursor is exposed by a laser and mounted on a printing machine to perform printing without undergoing the development processing step, and a method wherein the lithographic printing plate precursor is mounted on a printing machine, exposed by a laser on the printing machine to perform printing without undergoing the development processing step are exemplified.

After imagewise exposure of the lithographic printing plate precursor by a laser, when an aqueous ingredient and an oily ink are supplied to perform printing without undergoing the development processing step, for example, a wet development processing step, the image-recording layer hardened by exposure forms the oily ink receptive area having an oleophilic surface in the exposed area of the image-recording layer. On the other hand, in the unexposed area, the unhardened image-recordiiig layer is removed by dissolution or dispersion with the aqueous ingredient and/or oily ink supplied to reveal a hydrophilic surface in the area.

As a result, the aqueous ingredient is adhered on the revealed hydrophilic surface and the oily ink is deposited to the image-recording layer in the exposed area and printing is initiated. While either the aqueous ingredient or the oily ink may be supplied at first to the plate surface, it is preferred to supply the oily ink at first for preventing contamination of the aqueous ingredient with the image-recording layer in the unexposed area. For the aqueous ingredient and oily ink, dampening water and printing ink for conventional lithographic printing are used.

Thus, the lithographic printing plate precursor is subjected to the on-machine development on an offset printing machine and used as it is for printing plurality of sheets.

The invention will be described in more detail with reference to the following examples, but the invention should not be construed as being limited thereto.

### EXAMPLES 1 to 8

1. Preparation of Lithographic Printing Plate Precursor

(1) Preparation of Support

A 0.3 mm-thick aluminum plate (JIS 1050 material) was subjected to a degreasing treatment at 50° C. for 30 sec by using an aqueous 10% by weight sodium aluminate solution for removing rolling oil on the surface thereof and then grained the surface using three nylon brushes embedded with bundles of nylon bristle having a diameter of 0.3 mm and an aqueous suspension (specific gravity: 1.1 g/cm³) of pumice having a median particle size of 25 μm), followed by thorough washing. The plate was etched by immersing in an aqueous 25% by weight sodium hydroxide solution of 45° C. for 9 seconds, washed with water, then immersed in a 20% by weight nitric acid of 60° C. for 20 seconds and washed with water. The etching amount of the grained surface was about 3 g/m².

Then, using an alternating current of 60 Hz, an electrochenical roughening treatment was continuously carned out on the plate. The electrolyte used was an aqueous 1% by weight nitric acid solution (containing 0.5% by weight of aluminum ion) and the electrolyte temperature was 50° C. The electrochemical roughening treatment was conducted using an alternating current source, which provides a trapezoidal rectangular wave alternating current of 0.8 msec in time TP for the current to reach its peak from zero and 1:1 in duty ratio and using a carbon electrode as a counter electrode. A ferrite was used as an auxiliary anode. The current density was 30 A/dm² in the peak value of the electric current. To the auxiliary anode, 5% of the electric current from the electric source was provided. The quantity of electricity in the nitric acid electrolysis was 175 C/dm² in terms of the quantity of electricity when the aluminum plate functioning as an anode. The plate was then washed with water by spraying.

The plate was Amber subjected to electrochemical roughening treatment in the same manner as in the nitric acid electrolysis using as electrolyte, an aqueous 0.5% by weight hydrochloric acid solution (containing 0.5% by weight of aluminum ion) having temperature of 50° C. and under the condition that the quantity of electricity was 50 C/dm² in terms of the quantity of electricity during the aluminum plate functioning as an anode. The plate was then washed with water by spraying. The plate was subjected to an anodizing treatment using as an electrolyte, a 15% by weight sulfuric acid (containing 0.5% by weight of aluminum ion) at a current density of 15 A/dm² to form a direct current anodized film of 2.5 g/m², washed with water and dried to obtain Support A. The center line average roughness (Ra) of the support was measured using a stylus having a diameter of 2 μm and it was found to be 0.51 μm.

Support A was then immersed in an aqueous solution containing 0.1% by weight of sodium fluorozirconate and 1% by weight of sodium dihydrogen phosphate and having pH of 3.7 and temperature of 75° C. to perform a sealing treatment. Thereafter, the plate was treated with an aqueous 2.5% by weight sodium silicate solution at 30° C. for 10 seconds.

On the plate was coated Undercoating solution (1) shown below so as to have a dry coating amount of 10 mg/m² to prepare a support for using the experiments described below.

Undercoating solution (1)

| | |
|---|---|
| Undercoating compound (1) shown below | 0.017 g |
| Methanol | 9.00 g |
| Water | 1.00 g |

Undercoating Compound (1) 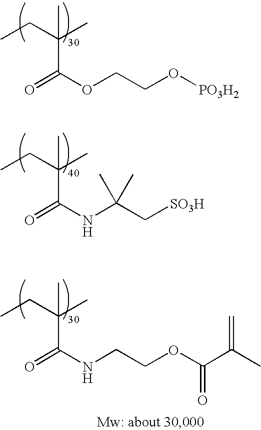
(2) Formation of Image-Recording Layer

On the support having the undercoat layer described above was coated Coating solution (1) for image-recording layer having the composition shown below by a bar and dried in an oven at 100° C. for 60 seconds to form an image-recording layer having a dry coating amount of 1.0 g/m² thereby preparing a lithographic printing plate precursor.

Coating solution (1) for image-recording layer was prepared by mixing and stirring Photosensitive solution (1) and Microcapsule solution (1) shown below just before the coating.

Photosensitive solution (1)

| | |
|---|---|
| Polymethyl methacrylate | 0.385 g |
| (weight average molecular weight: 120,000) | |
| Polymerization initiator (1) shown below | 0.100 g |
| Infrared absorbing agent (1) shown below | 0.020 g |
| EO chain-containing polymerizable | Amount shown |
| compound shown in Table 1 | in Table 2 |
| Fluorine-containing surfactant | 0.044 g |
| (Megafac F-176, manufactured by Dainippon | |
| Ink and Chemicals, Inc.) | |
| Methyl ethyl ketone | 1.091 g |
| 1-Methoxy-2-propanol | 8.609 g |

Microcapsule solution (I)

| | |
|---|---|
| Microcapsule (1) prepared shown below | 2.640 g |
| Water | 2.425 g |

Polymerization Initiator (1) 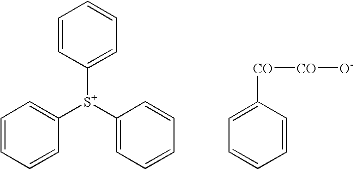
Infrared Absoring Agent (1) 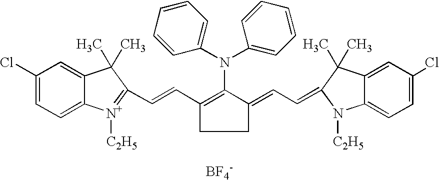
Preparation of Microcapsule (1)

An oil phase component was prepared by dissolving 10 g of adduct of trimethylol propane and xylene diisocyanate (Takenate D-110N, manufactured by Mitsui Takeda Chemical Co., Ltd.), 3.15 g of pentaerythritol triacrylate (SR444, manufactured by Nippon Kayaku Co., Ltd.), 0.35 g of Infrared absorbing agent (2) shown below, 1 g of 3-(N,N-diethylamino)-6-methyl-7-anilinofluoran (ODB, manufactured by Yamamoto Kasei Co., Ltd.) and 0.1 g of Pionine A-41C (manufactured by Takemoto Oil and Fat Co., Ltd.) in 17 g of ethyl acetate. As an aqueous phase component, 40 g of an aqueous 4% by weight solution of PVA-205 was prepared. The oil phase component and the aqueous phase component were mixed and emulsified using a homogenizer at 12,000 rpm rfor 10 minutes. The resulting emulsion was added to 25 g of distilled water and stirred at a room temperature for 30 minutes and then at 40° C. for 3 hours. The thus obtained microcapsule liquid was diluted using distilled water so as to have the solid concentration of 15% by weight. The average particle size of the microcapsule was 0.2 μm.

Infrared Absorbing Agent (2)

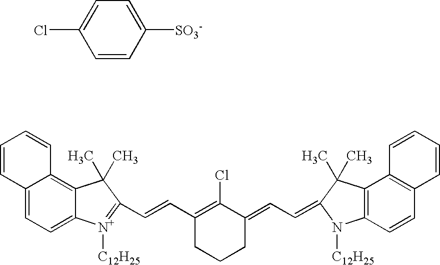

TABLE 1
Structure of EO chain-containing polymerizable compound

| EO | Content | |
|---|---|---|
| chain-containing polymerizable compound | of ethyleneoxy group (eq./g) | Chemical structure of compound |
| Monomer (1) | 13 × 10⁻³ | 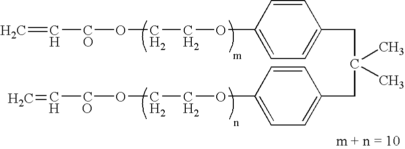 |
| Monomer (2) | 12 × 10⁻³ | 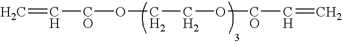 |
| Monomer (3) | 17 × 10⁻³ | 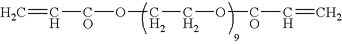 |
| Monomer (4) | 19 × 10⁻³ | 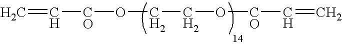 |
| Monomer (5) | 11 × 10⁻³ | 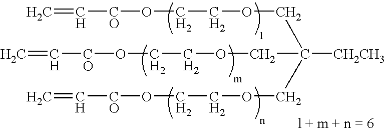 |
| Monomer (6) | 12 × 10⁻³ | 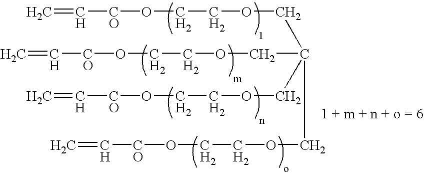 |
| Monomer (7) | 10 × 10⁻³ | 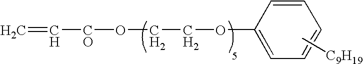 |
| Comparative Compound (1) | — | 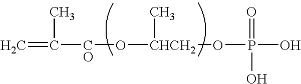 |
| Comparative Compound (2) | 10 × 10⁻³ | 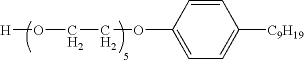 |

TABLE 2
Kind and amount of EO chain-containing polymerizable compound
used in example

| | Monomer | Monomer | Monomer | Monomer | Monomer | Monomer | Monomer |
|---|---|---|---|---|---|---|---|
| | (1) | (2) | (3) | (4) | (5) | (6) | (7) |
| Example 1 | 0.162 | — | — | — | — | — | — |
| Example 2 | — | — | — | — | 0.162 | — | — |
| Example 3 | — | — | — | — | — | 0.162 | — |
| Example 4 | 0.081 | 0.081 | — | — | — | — | — |
| Example 5 | — | — | 0.081 | — | 0.162 | — | — |
| Example 6 | — | — | — | 0.081 | — | 0.162 | — |
| Example 7 | — | — | — | — | 0.081 | — | 0.081 |
| Example 8 | 0.081 | 0.04 | — | — | — | 0.04 | — |

### COMPARATIVE EXAMPLE 1

A lithographic printing plate precursor was prepared in the same manner as in Example 1 except for using Comparative compound (1) in place of Polymerizable monomer (1) used in Photosensitive solution (1).

### COMPARATIVE EXAMPLE 2

A lithographic printing plate precursor was prepared in the same manner as in Example 1 except for replacing a half amount of Polymerizabie monomer (1) used in Photosensitive solution (1) to Comparative compound (2).

2. Evaluation of Lithographic Printing Plate Precursor

The lithographic printing plate precursor thus obtained was exposed by Trendsetter 3244VX, manufactured by Creo Co. equipped with a water-cooled 40 W infrared semiconductor laser under the conditions of a power of 9 W, a rotational number of an outer surface drum of 210 rpm and a resolution of 2,400 dpi. The exposed image contained a fine line chart. The exposed lithographic printing plate precursor was mounted without development processing on a plate cylinder of a printing machine SOR-MK manufactured by Hyderberg Co. After supplying dampening water (EU-3 (etching solution, manufactured by Fuji Photo Film Co., Ltd.)/water/isopropyl alcohol=1/89/10 (volume ratio)) and ink (TRANS-G (N) black ink (manufactured by Dainippon Ink and Chemicals, Inc.), 1,000 sheets of printing was conducted at a printing speed of 6,000 sheets per hour.

A number of printing papers required until on-machine development of the unexposed area of the image-recording layer on the printing machine was completed to reach a state where the ink was not transferred to the printing paper in the non-image area was measured as on-machine development property. As a result, in the case of using any of the lithographic printing plate precursors, printed materials without stain in the non-image area were obtained within the printing of 1,000 sheets.

Ordinarily, in a negative-working lithographic printing plate precursor, when hardening degree of the image-recording layer is too low, printing durability of the lithographic printing plate obtained decreases and reproducibility of small points and fine lines is deteriorated. On the contrary, when the hardening degree of the image-recording layer is high, the printing durability increases and the reproducibility of small points and fine lines is improved.

In the examples, the reproducibility of fine lines in the negative-working lithographic printing plate precursor was evaluated and it was used as an index of sensitivity of the negative-working lithographic printing plate precursor. Specifically, as a width of fine line in the reproducibility of fine lines is small, the sensitivity of the lithographic printing plate precursor becomes high. The fine line chart (a chart including fine lines having 10, 12, 14, 16, 18, 20, 25, 30, 35, 40, 60, 80, 100 and 200 μm in width) on the printed material was observed by a 25-power magnifier and the reproducibility of fine lines was evaluated from the width of fine line reproduced by ink without interruption. The results obtained are shown in Table 3 below.

Then, preservation aptitude of the lithographic printing plate precursor was evaluated. On the assumption that the lithographic printing plate precursor was stored under sever conditions, the lithographic printing plate precursor was stored in an environment of 35° C. and 50% RH for one month using a temperature and humidity controlled chamber (PR-3G, manufactured by Espec Corp.). After the storage, the lithographic printing plate precursor was subjected to the exposure and printing in the same manier as described above. As a result, it was found that only with a sample of the lithographic printing plate precursor in Comparative Example 1, the development was not completed after printing of 1,000 sheets to occur background stain due to ink.

The results obtained are shown in Table 3 below.

TABLE 3
Result of evaluation

| | | On-machine | |
|---|---|---|---|
| | On-machine | development | |
| | development | property after | |
| | property just after | accelerated aging | |
| | coating (1,000 | test (1,000 sheets | Reproducibility of |
| | sheets printing) | printing) | fine lines |
| Example 1 | ◯ | ◯ | 20 μm |
| Example 2 | ◯ | ◯ | 16 μm |
| Example 3 | ◯ | ◯ | 16 μm |
| Example 4 | ◯ | ◯ | 20 μm |
| Example 5 | ◯ | ◯ | 25 μm |
| Example 6 | ◯ | ◯ | 30 μm |
| Example 7 | ◯ | ◯ | 20 μm |
| Example 8 | ◯ | ◯ | 16 μm |
| Comparative | ◯ | X | 30 μm |
| Example 1 | | (background stain | |
| | | on printed material) | |
| Comparative | ◯ | ◯ | No image formed |
| Example 2 | | | |

It is apparent from Table 3 that according to the lithographic printing plate precursors (Examples 1 to 8) of the invention, not only the preservation stability increases but also the reproducibility of fine lines is improved in comparison with the cases where conventional lithographic printing plate precursors (Comparative Examples 1 and 2) are used.

### EXAMPLES 9 TO 18 AND COMPARATIVE EXAMPLE 3

On the support having the undercoat layer described in Examples 1 to 8 was coated Coating solution (2) for image-recording layer having the composition shown below by a bar and dried in an oven at 100° C. for 60 seconds to form an image-recording layer having a dry coating amount of 1.0 g/m² thereby preparing a lithographic printing plate precursor.

Coating solution (2) for image-recording layer was prepared by mixing and stirring Photosensitive solution (2) shown below and Microcapsule solution (1) shown above just before the coating.

Photosensitive solution (2)

| | |
|---|---|
| Polymethyl methacrylate | 0.218 g |
| (weight average molecular weight: 120,000) | |
| Polymerization initiator (1) shown above | 0.100 g |
| Infrared absorbing agent (1) shown above | 0.020 g |
| Polymerizable compound shown in Table 5 | 0.162 g |
| (structure being shown in Table 4) | |
| Fluorine-containing surfactant | 0.044 g |
| (Megafac F-176, manufactured by Dainippon | |
| Ink and Chemicals, Inc.) | |
| Methyl ethyl ketone | 1.091 g |
| 1-Methoxy-2-propanol | 8.609 g |

Microcapsule solution (1)

| | |
|---|---|
| Microcapsule (1) shown above | 2.640 g |
| Water | 2.425 g |

The lithographic printing plate precursor thus obtained was exposed in the same manner as in Examples 1 to 8. The exposed lithographic printing plate precursor was mounted without development processing on a plate cylinder of a printing machine SOR-M, manufactured by Hyderberg Co. While supplying dampening water (EU-3 (etching solution, manufactured by Fuji Photo Film Co., Ltd.)/water/isopropyl alcohol=1/89/10 (volume ratio)), the plate cylinder was rotated 40 times and then simultaneously with supplying ink (TRANS-G (N) black ink (manufactured by Dainippon Ink and Chemnicals, Inc.), 1,000 sheets of printing was conducted at a printing speed of 6,000 sheets per hour.

The reproducibility of fine lines was evaluated in the same manner as in Examples 1 to 8. The inking property and printing durability were evaluated as shown below. The results of evaluations are shown in Table 5 below.

(Inking Property)

After the initiation of printing, ink gradually adhered to the image-recording layer and consequently ink density on paper increased. A number of printing papers required until the ink density reaches to density of standard printed material was evaluated as the inking property.

(Printing Durability)

After the printing for the evaluation of reproducibility of fine lines, the printing was continued. As the increase in number of printing papers, the image-recording layer was gradually abraded to cause decrease in the ink receptivity, resulting in decrease of the ink density on printing paper. A number of printing papers used until the ink density (reflection density) decreased by 0.1 from that at the initiation of printing was determined to evaluate the printing durability.

TABLE 4
Structure of polymerizable compound

| Polymerizable compound | Content of hydroxy group (meq./g) | Chemical structure of compound |
|---|---|---|
| (1) | 3.4 | 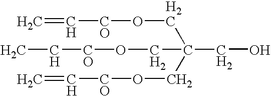 |
| (2) | 6.0 | 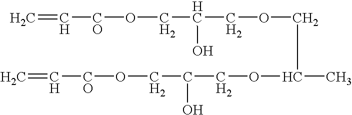 |
| (3) | 8.6 | 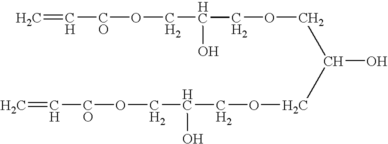 |
| (4) | 4.1 | 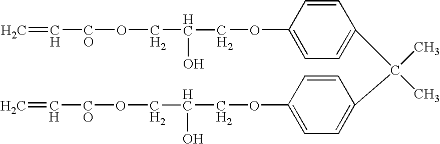 |
| (5) | 5.0 | 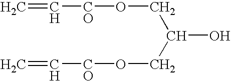 |
| (6) | 4.7 | 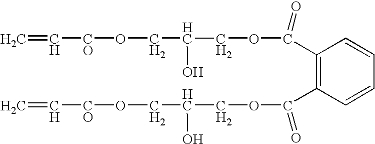 |
| (7) | 4.7 | 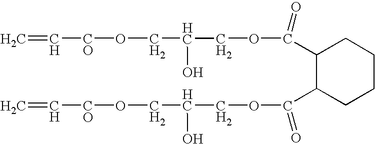 |
| (8) | 3.0 | 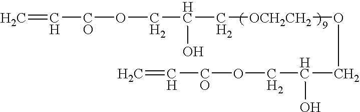 |
| (9) | 12 | 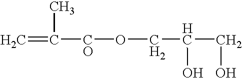 |
| (10) | 1.9 | 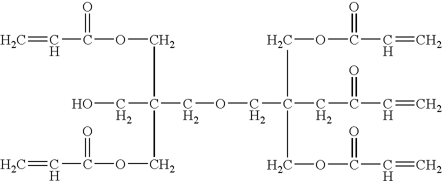 |
| Comparative Compound (11) | — | 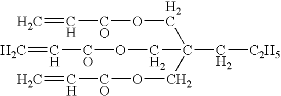 |

TABLE 5
Result of evaluation

| | Polymerizable | Content of | | | |
|---|---|---|---|---|---|
| | compound | hydroxy | | | |
| | containing | group | Inking | Printing | Reproducibility |
| | hydroxy group | (meq./g) | property | durability | of fine lines |
| Example 9 | (1) | 3.4 | 30 sheets | 10 × 10³ sheets | 16 μm |
| Example 10 | (2) | 6.0 | 30 sheets | 10 × 10³ sheets | 16 μm |
| Example 11 | (3) | 8.6 | 30 sheets | 15 × 10³ sheets | 16 μm |
| Example 12 | (4) | 4.1 | 30 sheets | 15 × 10³ sheets | 16 μm |
| Example 13 | (5) | 5.0 | 30 sheets | 10 × 10³ sheets | 16 μm |
| Example 14 | (6) | 4.7 | 30 sheets | 15 × 10³ sheets | 16 μm |
| Example 15 | (7) | 4.7 | 30 sheets | 15 × 10³ sheets | 16 μm |
| Example 16 | (8) | 3.0 | 30 sheets | 15 × 10³ sheets | 16 μm |
| Example 17 | (9) | 12.0 | 50 sheets | 10 × 10³ sheets | 20 μm |
| Example 18 | (10) | 1.9 | 40 sheets | 5 × 10³ sheets | 20 μm |
| Comparative | (11) | — | 50 sheets | 3 × 10³ sheets | 25 μm |
| Example 3 | | | | | |

It is apparent from Table 5 that the lithographic printing plate precursors (Examples 9 to 18) of the invention are improved in the printing durability, reproducibility of fine lines and inking property in comparison with the case where a conventional lithographic printing plate precursor (Comparative Example 3) is used.

### EXAMPLES 19 TO 22 AND COMPARATIVE EXAMPLES 4 and 5

On the support having the undercoat layer described in Examples 1 to 8 was coated each coating solution for image-recording layer having the composition shown in Table 6 below by a bar and dried in an oven at 100° C. for 60 seconds to form an image-recording layer having a dry coating amount of 1.0 g/m² thereby preparing each lithographic printing plate precursor of Examples 19 to 22 and Comparative Examples 4 and 5.

TABLE 6
Composition of coating solution for example and comparative example

| | Example | | | | Comparative Example | |
|---|---|---|---|---|---|---|
| | 19 | 20 | 21 | 22 | 4 | 5 |
| Number of coating solution | (1) | (2) | (3) | (4) | (5) | (6) |
| Infrared absorbing agent (3) shown below | 0.05 | 0.05 | 0.2 | 0.2 | 0.05 | 0.2 |
| Polymerization initiator (1) shown above | 0.2 | 0.2 | 1.0 | 1.0 | 0.2 | 1.0 |
| Binder polymer (1) shown below (weight average molecular weight: 80,000) | 0.5 | 0.5 | 1.6 | 1.6 | 0.5 | 1.6 |
| Hexa-functional acrylate *1) | — | — | — | — | 1.0 | 3.9 |
| Trisacryloyloxyethyl isocyanurate *2) | 1.0 | — | 3.9 | — | — | — |
| Diacryloyloxyethylhydroxyethyl isocyanurate *3) | — | 1.0 | — | 3.9 | — | — |
| Naphthalenosulfonate of Victoria Pure Blue | 0.02 | 0.02 | 0.01 | 0.01 | 0.02 | 0.01 |
| Fluorine-containing surfactant shown above | 0.1 | 0.1 | 0.8 | 0.8 | 0.1 | 0.8 |
| Microcapsule (2) prepared by method shown below (15 wt % aqueous solution) | — | — | 26.4 | 26.4 | — | 26.4 |
| Methyl ethyl ketone | 18.0 | 18.0 | 10.9 | 10.9 | 18.0 | 10.9 |
| Propylene glycol monomethyl ether | — | — | 86.1 | 86.1 | — | 86.1 |
| Water | — | — | 24.3 | 24.3 | — | 24.3 |

*1) Light acrylate DPE-6A, manufactured by Kyoeisha Chemical Co., Ltd.
*2) Alonix M-315, manufactured by Toagosei Co., Ltd.
*3) Alonix M-215, manufactured by Toagosei Co., Ltd.

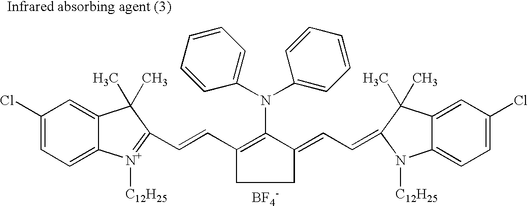

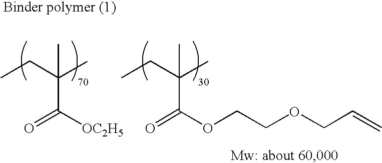

Preparation of Microcapsule (2)

An oil phase component was prepared by dissolving 10 g of adduct of trimethylol propane and xylene diisocyanate (Takenate D-110N, manufactured by Mitsui Takeda Chemical Co., Ltd.), 3.15 g of pentaerythritol triacrylate (SR444, manufactured by Nippon Kayaku Co., Ltd.), 0.35 g of Infrared absorbing agent (1) shown above, 1 g of 3-(N,N-diethylamino)-6-methyl-7-anilinofluoran (ODB, manufactured by Yamamoto Kasei Co., Ltd.) and 0.1 g of Pionine A-41C (manufactured by Takemoto Oil and Fat Co., Ltd.) in 17 g of ethyl acetate. As an aqueous phase component, 40 g of an aqueous 4% by weight solution of PVA-205 was prepared. The oil phase component and the aqueous phase component were mixed and emulsified using a homogenizer at 12,000 rpm for 10 minutes The resulting emulsion was added to 25 g of distilled water and stirred at a room temperature for 30 minutes and then at 40° C. for 3 hours. The thus obtained microcapsule liquid was diluted using distilled water so as to have the solid concentration of 15% by weight, The average particle size of the microcapsule was 0.2 μm.

### EXAMPLES 23 AND 24

On each of the image-recording layers of the lithographic printing plate precursors of Examples 21 and 22 was coated a coating solution for over coat layer having the composition shown below by a bar and dried in an oven at 100° C. for 90 seconds to form an over coat layer having a dry coating amount of 0.1 g/m² thereby preparing each lithographic printing plate precursor of Examples 23 and 24.

Coating Solution for over Coat Layer

| | |
|---|---|
| Polyvinyl alcohol (PVA-105, manufactured | 6.0 g |
| by Kuraray Co., Ltd., saponification degree: | |
| 98 mol %, polymerization degree: 500) | |
| Emalex 710 (surfactant, manufactured by | 0.1 g |
| Nippon-Emulsion Co., Ltd.) | |
| Polyvinylpyrrolidone K30 | 0.2 g |
| Luvitec VA64 (copolymer of vinyl pyrrolidone | 0.2 g |
| and vinyl acetate (6:4), manufactured by BASF) | |
| Water | 100.0 g |

### COMPARATIVE EXAMPLE 6

On the image-recording layers of the lithographic printing plate precursor of Comparative Example 5 was coated the coating solution for over coat layer having the composition shown above by a bar and dried in an oven at 100° C. for 90 seconds to form an over coat layer having a dry coating amount of 0.1 g/m² thereby preparing a lithographic printing plate precursor of Comparative Example 6.

The lithographic printing plate precursor thus obtained was exposed under the same conditions as in Examples 1 to 8. The exposed lithographic printing plate precursor was mounted without development processing on a plate cylinder of a printing machine Print 25, manufactured by Komori Corp. After supplying dampening water prepared by diluting IF-102 (manufactured by Fuji Photo Film Co., Ltd.) with tap so as to have concentration of 4% in volume and ink (TRANS-G (N) black ink (manufactured by Dainippon Ink and Chemicals, Inc.), printing was conducted at a printing speed of 8,000 sheets per hour. As a result, on-machine development was carried out to obtain good printed materials without stain.

After printing of 500 sheets, the printing machine was stopped and adhesion state of residue of the image-recording layer (residual scum) on a water-supplying roller was observed and evaluated according to the following index.

∘: No scum was observed on the water-supplying roller

□: A small amount of scum was observed on the water-supplying roller

x: A large amount of scum was observed on the water-supplying roller

After the evaluation of adhesion state of scum, the printing was further continued and the printing durability was evaluated in the same manner as in Examples 9 to 18. The results of evaluations are collectively shown in Table 7 below.

TABLE 7
Result of evaluation

| | Coating | | | Adhesion State |
|---|---|---|---|---|
| | solution | | | of residual |
| | number of | | | scum on water- |
| | image- | Over coat | Printing | supplying |
| | recording layer | layer | durability | roller |
| Example 19 | (1) | none | 7,500 sheets | ◯ |
| Example 20 | (2) | none | 7,500 sheets | ◯ |
| Example 21 | (3) | none | 4,000 sheets | ◯ |
| Example 22 | (4) | none | 6,000 sheets | ◯ |
| Example 23 | (3) | present | 5,500 sheets | ◯ |
| Example 24 | (4) | present | 8,000 sheets | ◯ |
| Comparative | (5) | none | 6,000 sheets | X |
| Example 4 | | | | |
| Comparative | (6) | none | 3,000 sheets | □ |
| Example 5 | | | | |
| Comparative | (6) | present | 1,000 sheets | □ |
| Example 6 | | | | |

It is apparent from Table 7 that the lithographic printing plate precursors (Examples 19 to 24) of the invention are extremely excellent in the adhesion state of residual scum of the image-recording layer on a water-supply roller and printing durability in comparison with the case where conventional lithographic printing plate precursors (Comparative Examples 4 to 6) are used.

The entire disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

1. A lithographic printing plate precursor comprising a support and an image-recording layer that contains (A) a radical polymerization initiator, (B) a polymerizable compound and (C) a lipophilic binder polymer substantially not containing an acid group and is capable of being removed with either or both of printing ink and dampening water, wherein the polymerizable compound has at least one structure selected from (1) an ethylene oxide chain, (2) an alcoholic hydroxy group and (3) an isocyanuric acid structure in the molecule thereof.

2. The lithographic printing plate precursor as claimed in claim 1, wherein the image-recording layer further contains (D) a light to heat converting agent.

3. The lithographic printing plate precursor as claimed in claim 1, wherein the support has an undercoat layer containing a compound having a crosslinking group.

4. The lithographic printing plate precursor as claimed in claim 3, wherein the compound further has an adsorbing group.

5. The lithographic printing plate precursor as claimed in claim 1, wherein the image-recording layer further contains (E) a microcapsule.

6. The lithographic printing plate precursor as claimed in claim 1, which further comprises a protective layer provided on the image-recording layer.

7. The lithographic printing plate precursor as claimed in claim 6, wherein the protective layer has a thickness of from 0.1 to 5 μm.

8. A lithographic printing method, which comprises; mounting the lithographic printing plate precursor as claimed in claim 1 on a printing machine and then imagewise exposing the lithographic printing plate precursor by a laser; or imagewise exposing the lithographic printing plate precursor as claimed in claim 1 by a laser and then mounting the exposed lithographic printing plate precursor to a printing machine;
and subsequently supplying printing ink and dampening water to the exposed lithographic printing plate precursor, thereby removing an unexposed area of the image-recording layer to conduct printing.
